(19) United States
(12) Patent Application Publication
(10) Pub. No.: US 2020/0164341 A1
(43) Pub. Date: May 28, 2020

(54) METHOD OF MAKING A MERCURY SORBENT

(71) Applicant: AMCOL INTERNATIONAL CORPORATION, Hoffman Estates, IL (US)

(72) Inventor: Zhen WANG, Lake Zurich, IL (US)

(21) Appl. No.: 16/560,785

(22) Filed: Sep. 4, 2019

Related U.S. Application Data
(63) Continuation of application No. 15/769,722, filed on Apr. 19, 2018, now abandoned.
(60) Provisional application No. 62/249,049, filed on Oct. 30, 2015.

(51) Int. Cl. B01J 20/12; B01J 20/30; B01J 20/22; B01J 20/04; B01J 20/02; B01D 53/83; B01D 53/64; B01J 20/06

(52) U.S. Cl. CPC B01J 20/12; B01D 2251/606; B01J 20/22; B01J 20/045; B01J 20/043; B01J 20/0281; B01D 53/83; B01J 20/0237; B01D 53/64; B01J 20/02; B01J 20/06; B01J 20/0266; B01D 2253/1128; B01D 2253/11; B01D 2257/602; B01D 2253/1122; B01J 20/3007

(57) ABSTRACT

Methods of preparing a mercury sorbent material are provided. The methods comprise making a copper/clay mixture by admixing a dry clay and a dry copper source; making a sulfur/clay mixture by admixing a dry clay and a dry sulfur source; admixing the copper/clay mixture and the sulfur/clay mixture, to form a mercury sorbent premixture; and shearing the mercury sorbent pre-mixture to form the mercury sorbent material. Various substrates may be used with or instead of the clay, and various additives may be added to the copper, sulfur, clay, or mixture thereof.

### CROSS-REFERENCE TO RELATED APPLICATION

This application claims the benefit of U.S. Provisional Patent Application No. 62/249,049, filed on Oct. 30, 2015, which is incorporated by reference herein in its entirety, expressly including any drawings.

### FIELD OF THE INVENTION

The present invention is directed to methods of manufacturing compositions used for the removal of mercury (organic mercury, Hg, Hg⁺; and/or Hg⁺²) from gas streams, e.g., natural gas, industrial smoke stacks, and the like; the compositions produced by the methods; and methods of using the compositions for removing mercury (organic mercury, Hg, Hg⁺; and/or Hg⁺²) from gas streams, e.g., natural gas, industrial smoke stacks, and the like. The compositions produced by the methods, “mercury removal media,” are particularly useful for removal of mercury from the flue gasses emitted by coal-burning electrical power plants. The mercury (Hg) removal media comprises a homogeneous, preferably sheared composition comprising a layered phyllosilicate, sulfur, and copper, resulting in a copper/sulfur/clay material, and additives may be added during the method of manufacturing the mercury (Hg) removal media. The copper is ion exchanged with clay cations and the sulfur reacts with the ion exchanged and free copper to form a phyllosilicate bound copper sulfide phase by a combination of mechanisms.

### BACKGROUND

Emissions of mercury from coal-fired and oil-fired power plants have become a major environmental concern. Mercury (Hg) is a potent neurotoxin that affects human health at very low concentrations. The largest source of mercury emission in the United States is coal-fired electric power plants. These coal-fired power plants account for between one-third and one-half of total mercury emissions in the United States.

The mercury emission is predominantly through the flue gas (exhaust gas) ejected from the burning coal. There are three basic forms of Hg in the flue gas: elemental Hg; oxidized Hg; and particle-bound mercury.

Currently, the most common method for mercury emissions reduction from coal-fired and oil-fired power plants is the injection of powdered activated carbon into the flue stream. The activated carbon provides a high surface area material for the adsorption of the mercury and the agglomeration of the particle bound mercury. The disadvantage of adding activated carbon into the flue stream is the retention of the activated carbon in the fly ash waste stream. Fly ash from coal-fired power plants is often added to concrete, where the presence of the activated carbon adversely affects the performance.

Another method for reducing Hg emissions is through the addition of chemical species that react with mercury to chem-adsorb the elemental Hg and oxidized Hg. One class of materials capable of chemically reacting with Hg is metal sulfides. U.S. Pat. No. 6,719,828 teaches the preparation of layered sorbents such as clays with metal sulfide between the clay layers. The method used to prepare the layered sorbents is based on an ion exchange process, which limits the selection of substrates to only those having high ion exchange capacity. In addition, the disclosed ion exchange is time-consuming, involving several wet process steps significantly impairing the reproducibility, performance, scalability, equipment requirements, and cost of the sorbent. The process of making a sorbent, in accordance with the teachings of U.S. Pat. No. 6,719,828, involves swelling a clay in an acidified solution, introducing a metal salt solution to exchange metal ions between the layers of the clay, filtering the ion exchanged clay, redispersing the clay in solution, sulfidating the clay by adding a sulfide solution, and finally filtering and drying the material. Another shortcoming of the process disclosed in U.S. Pat. No. 6,719,828 is the environmental liability of the by-products of the ion exchange process, i.e., the waste solutions of metal ions and the generated hydrogen sulfide.

Published U.S. patent application Ser. No. 11/291,091 (U.S. Pat. No. 7,578,869, issued on Aug. 25, 2009) teaches the preparation of metal sulfide/bentonite composites for the removal of mercury from flue gas streams. The application teaches two methods, an incipient wetness process and a solid-state reactive grinding process, to prepare the composites. The processes are similar in that a copper salt is mixed with a bentonite clay and then a sulfide salt is added. The processes differ in the method of addition of the sulfide salt. In the first method, the sulfide salt is added through an “incipient wetness” procedure where the sulfide salt is dissolved in water and added to the copper/clay mixture as an aqueous solution; in the second method, the sulfide salt is added through a “solid-state reactive grinding” process where the sulfide salt hydrate is ground with the hydrated copper/clay mixture. The application further teaches that the incipient wetness and solid-state grinding methods differ from the “wet” method of U.S. Pat. No. 6,719,828 because there is no ion-exchange of the copper ion for the cationic ions of the bentonite clay. The composite nature of the materials produced in the application are supported by powder X-ray diffraction spectra that provide evidence of the formation of covellite (CuS), the same copper sulfide prepared in U.S. Pat. No. 6,719,828.

While U.S. application Ser. No. 11/291,091 (U.S. Pat. No. 7,578,869, issued on Aug. 25, 2009) disclaims ion exchange, copper salts and bentonite clays readily and easily ion exchange to yield very stable copper/clay compositions. See e.g., Ding, Z. and R. L. Frost, “Thermal study of copper adsorption on montmorillonites” Thermochimica Acta, 2004, 416: 11-16. Analytical analysis of these compositions confirms both interlayer ion-exchange (intercalation) and edge adsorption of the copper salt. See e.g., El-Batouti et al. “Kinetics and thermodynamics studies of copper exchange on Na-montmorillonite clay mineral,” J. Colloid and Interface Sci., 2003, 259: 223-227.

U.S. Pat. No. 8,268,744 describes a process for manufacturing a mercury sorbent. However, there is still an ongoing need to provide improved pollution control sorbents and methods of their manufacture. It would be desirable to provide an improved process for easily and inexpensively manufacturing sorbents containing metal sulfides on substrates.

### SUMMARY

Methods for manufacturing a mercury sorbent material and the mercury sorbent material produced. The methods involve manufacturing a mercury sorbent material from a clay, a copper source, and a sulfur source, and optionally, an additive.

Methods for manufacturing a mercury sorbent material and the mercury sorbent material produced. Methods for manufacturing a mercury sorbent material by making a copper/clay mixture by admixing a dry clay, having less than about 15% by weight water, and a dry copper source, having a water content that consists essentially only of its molecular water of hydration, and optionally an additive; making a sulfur/clay mixture by admixing a dry clay, having less than about 15% by weight water, and a dry sulfur source, having a water content that consists essentially only of its molecular water of hydration, and optionally an additive; admixing the copper/clay mixture and the sulfur/clay mixture and optionally an additive to form a mercury sorbent pre-mixture, and shearing the mercury sorbent pre-mixture to form the mercury sorbent material. In some embodiments, the mercury sorbent material produced by the methods has an interlayer d(001)-spacing of less than 12 Å when the mercury sorbent material contains less than about 4 wt. % water, wherein a powder X-ray diffraction pattern of the mercury sorbent material is substantially free of a diffraction peak at 2.73±0.01 Å. In some embodiments, the ζ-potential (zeta potential) of the mercury sorbent material is greater than the ζ-potential of the dry clay. In the preferred embodiment, shearing is accomplished by passing the mercury sorbent material through an extruder at a moisture content of about 15% to about 40% by weight, more preferably about 20% to about 30% by weight.

### BRIEF DESCRIPTION OF THE DRAWINGS

FIG. 1 is an exemplary process diagram for making mercury sorbent material by shear mixing;

FIG. 2 is a drawing of a montmorillonite structure indicating the d(001)-spacing as can be determined by powder X-ray diffraction;

FIG. 3 is a composite drawing of powder X-ray diffraction patterns for sodium montmorillonite. The lines represent the low-angle diffraction patterns for the sodium montmorillonite containing from about 0.9 wt. % to about 24.4 wt. % water;

FIG. 4 is a composite drawing of powder X-ray diffraction patterns for a herein described mercury sorbent material. The lines represent the low-angle diffraction patterns for the material containing from about 0.6 wt. % to about 22 wt. % water; and

FIG. 5 is a composite drawing of the powder X-ray diffraction pattern between about 30 and 35 2Θ for samples of a sodium montmorillonite, a sodium montmorillonite containing about 4.5 wt. % covellite, and the herein described mercury sorbent material containing the equivalent of 4.5 wt. % copper sulfide.

### DETAILED DESCRIPTION

The phrase “as used herein” encompasses all of the specification, the abstract, the drawings (figures), and the claims.

As used herein, use of the singular herein includes the plural and vice versa unless expressly stated to be otherwise. That is, “a” and “the” refer to one or more of whatever the word modifies. For example, “a particle” may refer to one particle, two particles, etc. Likewise, “the substrate material” may refer to one, two or more substrate materials. By the same token, words such as, without limitation, “substrate materials” would refer to one substrate material as well as to a plurality of substrate materials unless it is expressly stated or obvious from the context that such is not intended.

As used herein, unless specifically defined otherwise, any words of approximation such as without limitation, “about,” “essentially,” “substantially,” and the like mean that the element so modified need not be exactly what is described but can vary from the description. The extent to which the description may vary will depend on how great a change can be instituted and have one of ordinary skill in the art recognize the modified version as still having the properties, characteristics and capabilities of the unmodified word or phrase. With the preceding discussion in mind, a numerical value herein that is modified by a word of approximation may vary from the stated value by ±15% in some embodiments, by ±10% in some embodiments, by ±5% in some embodiments, or in some embodiments, may be within 1.0 the 95% confidence interval.

As used herein, all numbers which represent physical values or measurements are subject to normal variation and measurement errors.

As used herein, any ranges presented are inclusive of the end-points. For example, “a temperature between 10 ° C. and 30 ° C.” or “a temperature from 10 ° C. to 30 ° C.” includes 10 ° C. and 30 ° C., as well as any temperature in between. In addition, throughout this disclosure, various aspects of this invention may be presented in a range format. The description in range format is merely for convenience and brevity and should not be construed as an inflexible limitation on the scope of the invention. Accordingly, the description of a range should be considered to have specifically disclosed all the possible subranges as well as individual numerical values within that range. As an example, a description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Unless expressly indicated, or from the context clearly limited to integers, a description of a range such as from 1 to 6 should be considered to have specifically disclosed subranges 1.5 to 5.5, etc., and individual values such as 3.25, etc. that is non-integer individual values and ranges beginning with, ending with or both beginning with and ending with non-integer value(s). This applies regardless of the breadth of the range.

As used herein, a range may be expressed as from “about” one particular value and/or to “about” another particular value. When such a range is expressed, another embodiment is included, the embodiment being from one particular value and/or to the other particular value. Similarly when values are expressed as approximations by use of the antecedent “about,” it will be understood that the particular value forms another embodiment. As a non-limiting example, if “from about 1 to about 4” is disclosed, another embodiment is “from 1 to 4,” even if not expressly disclosed. Likewise, if one embodiment disclosed is a temperature of “about 30 ° C.,” then another embodiment is “30 ° C.,” even if not expressly disclosed.

As used herein, the use of “preferred,” “preferably,” or “more preferred,” and the like to modify an aspect of the invention refers to preferences as they existed at the time of filing of the patent application.

As used herein, “optional” means that the element modified by the term may or may not be present.

As used herein, the phrase “any combination of” followed by a list joined by the conjunction “and,” means any combination of two or more members of the group where the group members are the members of the list joined by the conjunction “and.” As a non-limiting example, “any combination of A, B, C, and D” encompasses the following combinations: A and B; A and C; A and D; B and C; B and D; C and D; A, B, and C; A, B, and D; A, C, and D; B, C, and D; A, B, C, and D. Similarly, when a phrase such as “X is A, B, C, D, or a combination thereof” means X is A, X is B, X is C, X is D, or X is “any combination of A, B, C, and D” where the above definition of “any combination thereof” applies.

As used herein, the phrase “wt. %” refers to percent by weight.

As used herein, when referring to the composition of a mercury sorbent material product, the wt. % is the wt. % after the mercury sorbent material has been dried such that there is 5 wt. % water and/or solvent, or a lower content of water and/or solvent.

An angstrom (Å) is a unit of length equivalent to 10⁻¹⁰ meters, or 1 Å=1×10⁻¹⁰ meter.

A micron is a unit of length equivalent to 10⁻⁶ meters, or 1 micron=1 μm=1×10⁻⁶ meter.

As used herein, a reference to screening through a particular mesh size screen refers to Standard U.S. mesh sizes.

As used herein, “particle” is a piece of matter held together by physical bonding of molecules, an agglomeration of pieces of matter (“particles”) held together by colloidal forces and/or surface forces, a piece of matter which is held together by chemical bonds such as a cross-linked polymer network, a piece of matter formed by ionic interactions, or a piece of matter held together by any combination of agglomeration, surface forces, colloidal forces, ionic interactions, and chemical bonds. For the purposes of this disclosure, a particle will be defined as ranging in size from less than a one tenth of a nanometer to several centimeters in size.

The polydispersity of a plurality of particles represents the distribution of sizes, usually expressed as particle diameters, within a plurality of particles. The average diameter can be a number average diameter, where the number average diameter=Σᵢdᵢnᵢ/Σᵢnᵢ where nᵢ represents the number of particles with a diameter represented by dᵢ. Usually approximations are made and the distribution of particles by diameters is represented as a histogram, or in other words the particles are divided into smaller groups encompassing a smaller range of diameters and each of these groups is assigned a diameter near the center of that range. The surface area average diameter is determined by (Σᵢfᵢdᵢ²)^{1/2}, and the volume average diameter is determined by (Σᵢfᵢdᵢ³)^{1/3}, where fᵢ is nᵢ/Σᵢnᵢ. Thus, in the case of the surface area average diameter, the weighting factor is the surface area represented by the class of particles of diameter dᵢ, while for the volume average diameter, the weighting factor is the volume represented by each class of particles of diameter dᵢ. Since the surface area increases with diameter squared and the volume increases with diameter cubed, the surface area average diameter is greater than the number average diameter, and the volume average diameter exceeds the surface area average diameter. The mass or weight average diameter is the same as the volume average diameter if the density of all of the particles is the same. Similarly, distributions of particle sizes may be based on the number, surface area, or volume of the particles.

Another means for determining the average diameter is by the use of dynamic light scattering, which is also called photon correlation spectroscopy, and measures the diffusion of the particles in solution. The average diameter is the mean hydrodynamic diameter, and is close to the volume-average diameter. One method is outlined in the International Standards Organization (“ISO”) 13320.

The distribution of the particle sizes in a plurality may be represented by the standard deviation, which is a well-known statistical measurement. The standard deviation may be suitable for a narrow particle size distribution. Other measures of polydispersity include the d10 and d90 which refer to the diameters representing the threshold where 10% of the distribution falls below, and 90% of the distribution falls below, respectively. The average may be referred to as a d50. Thus, for a number average, half or 50% of the number of particles have a diameter less than the d50. For a volume average diameter, the d50 represents the diameter where half the volume represented by the plurality is in particles having a diameter smaller than d50, or in other words, the intersection of the 50% line on a plot of the cumulative volume of the particles as a function of diameter.

As used herein, unless specified otherwise, a reference to an average or mean particle diameter refers to a particle diameter as determined by photon correlation spectroscopy which is close to a volume average particle diameter. Non-spherical particles are approximated as spheres.

As used herein, unless specified otherwise, a reference to an average molecular weight of a polymer (or macromolecule) refers to the weight average molecular weight.

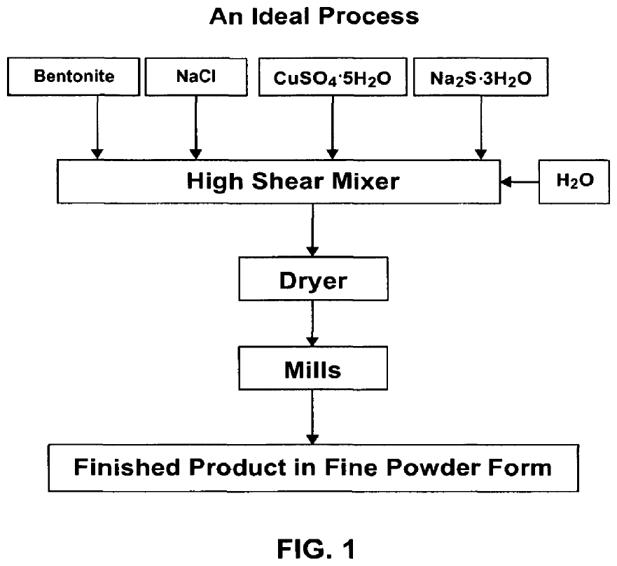

Improvements in the methods of U.S. Pat. No. 8,268,744 are described herein, and products produced by the improved methods. The methods described in U.S. Pat. No. 8,268,744 are described and then the improvements therein are described. An exemplary method is shown in FIG. 1 where the addition of sodium chloride is optional.

The improved methods described herein are used to form mercury sorbent material which is a copper and sulfur containing layered clay material made by the shearing of the sorbent components, particularly clay, a copper source, and a sulfur source. The methods disclosed herein are effectuated by both the ion exchange of clay cations with cations of the sorbent copper component and the disruption of the standard reaction pathways. Analytical analyses of the mercury sorbent material produced by the shearing methods described herein show that the materials produced do not include the kinetic reaction products described in the prior art, and it is expected that the improved methods described herein will produce mercury sorbent materials with similar properties. In some embodiments, the method produces a product which does not exhibit, taking into consideration background noise, a diffraction peak at 2.73±0.01 Å when a powder X-ray diffraction pattern of the mercury sorbent material is obtained, or the product is substantially free of a diffraction peak at 2.73±0.01 Å when a powder X-ray diffraction pattern of the mercury sorbent material is obtained.

In accordance with one aspect of the methods disclosed herein, the mercury sorbent materials produced by the methods disclosed herein includes a silicate clay material. The silicate clay (phyllosilicate) can be a smectite clay, e.g., bentonite, montmorillonite, hectorite, beidellite, saponite, nontronite, volkonskoite, sauconite, and/or stevensite, and/or a synthetic smectite derivative, particularly fluorohectorite and laponite; a mixed layered clay, particularly rectonite and their synthetic derivatives; vermiculite, illite, micaceous minerals, and their synthetic derivatives; layered hydrated crystalline polysilicates, particularly makatite, kanemite, octasilicate (illierite), magadiite and/or kenyaite; attapulgite, palygorskite, and/or sepoilite; or any combination thereof. The clay material should have exchangeable cations. Preferably, the silicate clay material is a montmorillonite with exchangeable calcium and/or sodium ions. Clay materials may be used in combination.

Another important aspect of the methods disclosed herein is the use of a reactive copper compound. As used herein, a reactive copper compound is a copper containing material that reacts with sulfur and/or sulfide ions. The reactive copper compounds provide the methods and materials disclosed herein a copper source. The copper source is preferably a dry material. A dry copper source is herein defined as a reactive copper compound that is in a powdered, flake, or crystalline form that does not contain water in excess of any water(s)-of-hydration within the crystalline structure of the solid copper compound. When used with reference to a copper source, “a water content that consists essentially only of its molecular water of hydration,” means that the water content may be up to 10%, up to 5%, or up to 3% greater, by weight, than the amount of water that is equivalent to the molecular water of hydration, which can be determined by one of skill in the art. (As an example, if the water of hydration is 5 grams of 1.0 water for every 95 grams of copper source, then for a 10% greater weight of water, it would be 5.5 grams, which is (5+0.5)/(100+0.5)*100%=5.472% water in the copper substance). Non-limiting examples of copper compounds that provide a copper source include the anhydrous and hydrous forms of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper metal, copper alloy, and mixtures thereof. Preferably, the copper source is a Cu(II) salt having a copper cation and a copper salt anion, more preferably the copper source is a Cu(II) salt where the pairing of the copper salt anion with a sodium ion is enthalpically preferable to the pairing with the copper cation, even more preferably the copper source is a Cu(II) salt where the pairing of the copper salt anion with a calcium cation is enthalpically preferable to the pairing with the copper cation, still more preferably the copper source is copper sulfate. Combinations of reactive copper compounds may be used.

Yet another important aspect of the methods disclosed herein is the use of a reactive sulfur compound. As used herein, a reactive sulfur compound is a sulfur containing material that reacts with copper and/or copper ions and provides a sulfur atom or polysulfide. The reactive sulfur compounds provide the methods and materials disclosed herein a sulfur source. The sulfur source is preferably a dry material. A dry sulfur source is defined herein as a reactive sulfur compound that is in a powdered, flake, crystalline, or gaseous form and does not contain water in excess of any water(s)-of-hydration within the crystalline structure of a solid sulfur source. When used with reference to a sulfur source, “a water content that consists essentially only of its molecular water of hydration,” means that the water content may be up to 10%, up to 5%, or up to 3% greater, by weight, than the amount of water that is equivalent to the molecular water of hydration, which can be determined by one of skill in the art. (see example above). Non-limiting examples of sulfur compounds that provide a sulfur source include the anhydrous and hydrous forms of sodium sulfide, sodium disulfide, sodium polysulfide, ammonium sulfide, ammonium disulfide, ammonium polysulfide, potassium sulfide, potassium disulfide, potassium polysulfide, calcium polysulfide, and mixtures thereof. Non-limiting examples of sulfur compounds that provide a sulfur source include the anhydrous forms of sulfur, hydrogen sulfide, hydrogen disulfide, aluminum sulfide, magnesium sulfide, thiolacetic acid, thiobenzoic acid, and mixtures thereof. Preferably, the sulfur source is a sulfide or polysulfide salt, more preferably the sulfide source is a sulfide salt, even more preferably, the sulfide source is a sodium sulfide, still more preferably the sulfide source is selected from Na₂S, Na₂S·3H₂O, and Na₂S·9H₂O, and even still more preferably the sulfide source is Na₂S·3H₂O. Combination of reactive sulfur compounds may be used.

Still another important aspect of the methods disclosed herein is an absence of a copper+sulfur chemical reaction prior to the shearing of the reactive compounds. One means for preventing copper+sulfur reactivity prior to the shearing of the compounds is by diluting the copper source and the sulfur source with the clay material. One of ordinary skill in the art would recognize that reaction rates are dependent on concentration and that the reaction of the copper source and the sulfide source would be similarly dependent. Moreover, the reaction of the copper source and the sulfide source is inhibited by the absence of free water. The addition of water and the possible formation of copper solutions and/or sulfide solutions would greatly enhance the reaction rates between the copper source and the sulfide source. Herein, any solid state reaction would be dependent on the mobility of the ions and the exposed surface area of the copper source and sulfide source, and therefore this solid state reaction would be very slow.

Preferably, the copper source is mixed with the clay material prior to the addition of this copper/clay mixture to a mechanical shearing apparatus, as disclosed below. Similarly, the sulfur source is preferably mixed with the clay material prior to the addition of this sulfur/clay mixture to a mechanical shearing apparatus. Optionally, the copper/clay mixture and the sulfur/clay mixture can be admixed to form a mercury sorbent pre-mixture prior to the addition of the mercury sorbent pre-mixture to a mechanical shearing apparatus. Yet another method of providing the materials to a mechanical shearing apparatus is by admixing the clay material with the copper source and the sulfur source (optionally, first adding the copper source to the clay materials, then adding the sulfur source of the mercury sorbent pre-mixture or any variation in order thereof). One of ordinary skill would appreciate that the order of addition would vary dependent on the specific (reactive compound) sources. Alternatively, the copper/clay and sulfur/clay mixtures can be added independently to a mechanical shearing apparatus. The addition of single or multiple dry materials to a mechanical shearing apparatus can be by any means available to one of ordinary skill in the art.

In one embodiment, the copper/clay mixture and the sulfur/clay mixture are produced and admixed in a single process wherein the copper source and the sulfur source are added to the clay material. The mixture is then stirred to distribute the copper source and the sulfur source throughout the clay material with a non-shearing mixer to form a mercury sorbent pre-mixture. An example of a non-shearing mixer is a paddle-type mixer.

The masses of added copper source to added sulfide source are adjusted to provide the preferred molar ratios of copper ion and sulfide ion, that are understood to be a measure of the copper atoms and sulfur atoms. For example, when the sulfide source is a polysulfide, the copper ion to sulfide ion ratio represents the molar ratio of copper atoms (ions) to sulfur atoms, the latter having a formula of Sₓ²⁻ where X is greater than 1. The ratio of copper ion to sulfide ion is in the range of about 0.1 to about 10, about 0.2 to about 5, or about 0.3 to about 3. Preferably, the ratio (Cu:S) is about 0.1, 0.2, 0.3, 0.4, 0.5, 0.7, 0.9, 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. When the sulfide source is a polysulfide, the ratio is generally less than 1. In one preferable embodiment the copper ion to sulfur ion ratio is less than about 1, more preferably less than about 0.5; in another preferable embodiment the ratio is greater than about 1, more preferably greater than about 2. In some embodiments, the ratio (Cu:S) is in the range of 0.1 to 2.

The copper source is added to the clay material in a weight ratio approximately consistent with the clay's cationic exchange capacity. The cationic exchange capacity is a measure of the molar equivalents of exchangeable clay cations and the weight ratio is a measure of the molar equivalents of cationic copper ions added to the clay. Preferably the addition of the copper source to the clay material is such that about 10 to about 300 millimoles (mmol) of copper are added to about 100 g clay, more preferably about 20 to about 200 mmol Cu to about 100 g clay, still more preferably about 50 to about 150 mmol Cu to about 100 g clay.

Still another important aspect of the methods presented herein is the shearing of the mercury sorbent pre-mixture. Mechanical shearing methods may employ extruders, injection molding machines, Banbury® type mixers, Brabender® type mixers, pin-mixers, and the like. Shearing also can be achieved by introducing a copper/clay mixture and a sulfur/clay mixture at one end of an extruder (single or double screw) and receiving the sheared material at the other end of the extruder. The temperature of the materials entering the extruder, the temperature of the extruder, the concentration of materials added to the extruder, the amount of water added to the extruder, the length of the extruder, residence time of the materials in the extruder, and the design of the extruder (single screw, twin screw, number of flights per unit length, channel depth, flight clearance, mixing zone, etc.) are several variables which control the amount of shear applied to the materials.

Preferably, water is added to the mechanical shearing unit to facilitate the shearing of the mercury sorbent pre-mixture as well as the reactions of the copper with the clay (ion exchange), and the copper with the sulfur. Due to the variability in the design of most mechanical shearing units, e.g. the feed capacity, the amount of water added to the unit is preferably defined by the weight percentage (wt. %) of water in the sheared material. Preferably, the mercury sorbent material, after exiting the mechanical shearing unit, comprises about 15 wt. % to about 40 wt. % water, more preferably about 20 wt. % to about 30 wt. % water, even more preferably about 23 wt. % to about 28 wt. % water.

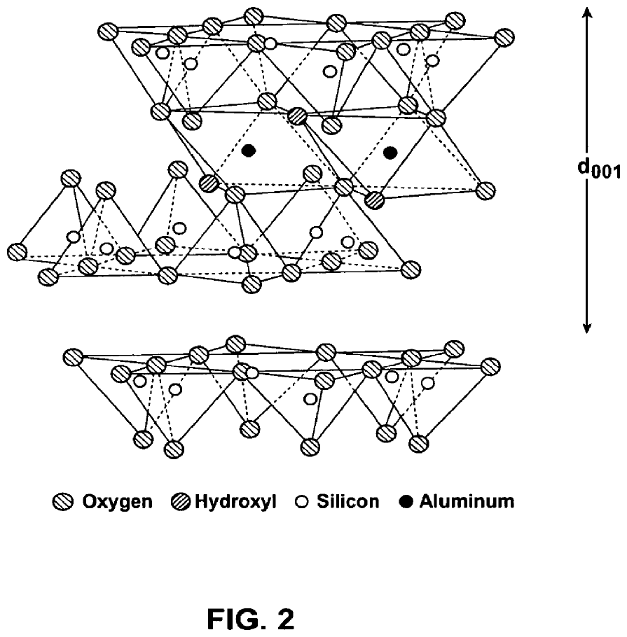

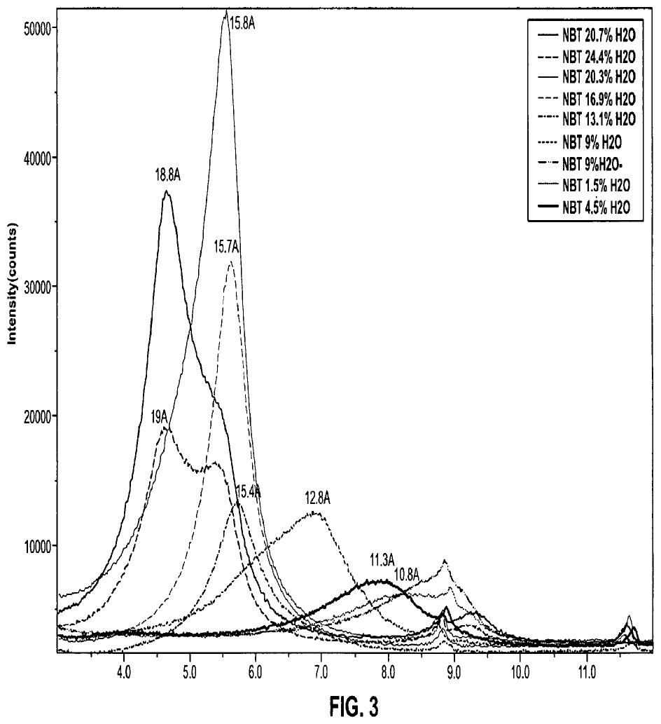

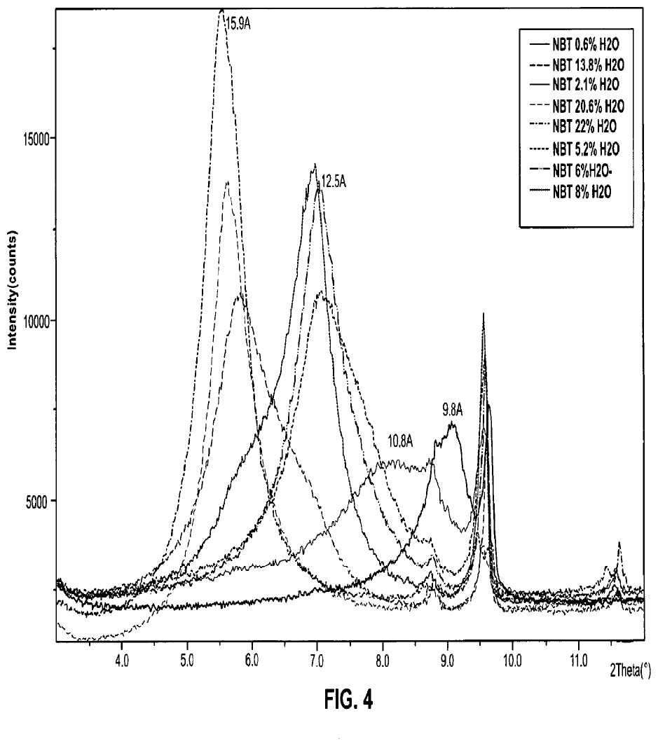

One method for determining the structure and composition of the materials disclosed herein is through powder X-ray diffraction (powder XRD). The powder XRD patterns of clay materials are characterized by a broad, low angle peak corresponding to the inter-silicate-layer spacing. See FIG. 2. Often used to determine the moisture content of water swellable clays, the angle where the peak maximum of this low angle peak decreases with increasing inter-layer spacing, see FIG. 3, wherein the peak maximum decrease with increasing water adsorbed into the inter-layer space. For example, a diffraction angle of about 7° two theta (2Θ) in a sodium montmorillonite clay corresponds to an interlayer d(001) spacing of about 12 Å and an angle of about 9° 2Θ corresponds to an interlayer d(001) spacing of about 9 Å, close to the thickness of the clay platelet. Changes to the interlayer d(001) spacing for montmorillonite clays and clay samples with added copper ion was thoroughly investigated by Burba and McAtee in “The Orientation and Interaction of Ethylenediamine Copper (II) with Montmorillonite,” Clays and Clay Minerals, 1977, 25: 113-118. Therein, the intercalation and multi-platelet binding of copper ions was reported and an average interlayer d(001) spacing for Cu(II) montmorillonite samples was about 12.5 Å. The layered copper-sulfide//silicate//copper-sulfide materials disclosed in U.S. Pat. No. 6,719,828 would have a interlayer d(001) spacing significantly greater than 12.5 Å due to the added thickness of the copper-sulfide layers. The surface deposited copper sulfide materials disclosed in U.S. patent application Ser. No. 11/291,091 (U.S. Pat. No. 7,578,869) would exhibit the same interlayer d(001) spacing as the original montmorillonite (e.g., FIG. 3) because, as taught, the copper-sulfide, therein, deposits only on the surface of the clay. Herein, the methods and materials were found to have interlayer d(001) spacings less than about 12 Å when the moisture content of the materials was less than 4 wt. %. See e.g., FIG. 4. Indicating that the materials and methods described herein do not conform to the structures taught in the prior art.

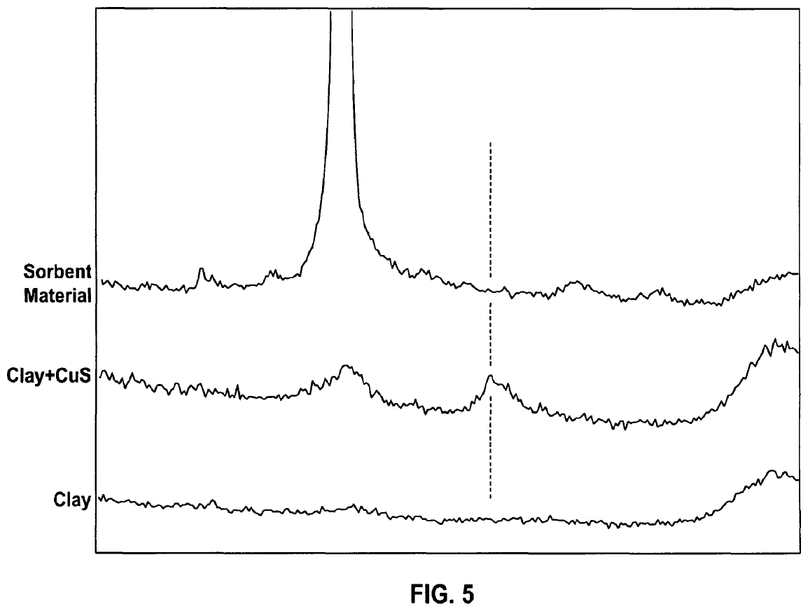

Moreover, the mercury sorbent materials produced by the methods disclosed herein are substantially free of covellite, the copper sulfide mineral disclosed in U.S. patent application Ser. No. 11/291,091 (U.S. Pat. No. 7,578,869). As used herein, the term “substantially free of covellite” may be not more than 1 wt. % covellite, not more than 0.5 wt. % covellite, or not more than 0.3 wt. % covellite. Covellite is the kinetic product of copper(II) ions with sulfide (S²⁻) ions and has a formula of CuS. The powder XRD pattern of covellite contains at least four signature reflections; three of these reflections overlap with reflections in montmorillonite clay materials. The reflection at 2.73±0.01 Å (where the variability in the location of the reflection is dependent in part on the accuracy of the diffractometer) is characteristic of the covellite material and is observable in clay predominating samples. FIG. 5 shows three powder XRD pattern in the 30° to 35° 2Θ range. The XRD pattern for copper sulfide free clay is shown on the bottom; the XRD pattern for clay containing 4.5 wt. % covellite is shown in the middle; the XRD patter for a herein disclosed clay material containing the equivalent of 4.5 wt. % copper sulfide is shown on the top. The covellite reflection at 2.73 Å was marked with a vertical dashed line. As is clearly indicated by the powder XRD pattern the herein disclosed material is substantively free of the diffraction peak at 2.73±0.01 Å, where “substantively free of the diffraction peak at 2.73±0.01 Å” may be a diffraction peak that is not larger than the diffraction peak of a substance with 1 wt. % covellite, 0.5 wt. % covellite, or 0.3 wt. % covellite.

Yet another important aspect of the methods disclosed herein are zeta (ζ)-potential values for the mercury sorbent materials produced by the methods disclosed herein being higher (less negative) then the ζ-potential values for the clay materials used to manufacture the mercury sorbent materials. The surface charge on a microparticulate, e.g., a clay, can often be determined by a measurement of the ζ-potential and/or electrophoretic mobility. The structures of the clays applicable herein are composed in part of silicon-oxygen (silicate) arrangements as described by Bragg et. al. in Crystal Structures of Minerals, pp. 166-382 (Cornell University Press 1965), and incorporated herein for the structures and formulas of silicate materials. The silicate portion of a clay often has an anionic charge that is balanced in the material by the inclusion of Alkali Metal and/or Alkali Earth cations. The suspension of these materials and measurement of their ζ-potential provides a means for assessing the ion paring (cations to silicate) in the clay material. The lower (more negative) the ζ-potential the greater the percentage of weak ionic interactions between the cations and the silicate. Higher (less negative) ζ-potentials indicate stronger ionic interactions or covalent interactions between the cations and the silicate. The blending of neutral materials with the clay material would not be expected to change the ζ-potential of the clay material. Ion exchange of the Alkali Metal and/or Alkali Earth cations of the clay material would be expected to change the ζ-potential if the exchanged for ion has a different binding energy with the silicate.

Still another important aspect of the methods disclosed herein is the material produced by the methods described herein is of a material particle diameter that can be trapped by particulate collectors in coal-fired electrical power plants. Preferably, average particle diameters are greater than 0.1 μm, still more preferably greater than 1 μm. The preferred average particle diameter of the mercury sorbent materials described herein, for the sorption of mercury in flue gases, is dependent on the particulate collectors at the individual power plants. Examples of particulate collectors include bag-house fabric filters, electrostatic precipitators, and cyclone collectors. Generally and well known in the art, larger particles are easier to remove from flue gasses. Preferably, the majority (at least 50%) of particles have a diameter in the range of about 1 to about 100 μm, more preferably in the range of about 1 to about 50 μm, most preferably about 10 to about 25 microns.

Unexpectedly, the shearing processes did not reduce the size of the materials disclosed herein as described above. Shearing, specifically high-shear mixing, is well known to reduce the particle size of clay materials by delamination of the silicate layers. Herein, the sheared materials were found to have larger particle diameters than those of the dry (less than about 15% by weight moisture content) clay starting material. Moreover, the particle diameter distribution was found to vary based on the mechanical shearing method. Samples that were sheared with a pin-mixer were found to have a majority average particle diameter of about 3.8 μm and a minority average particle diameter of about 20 μm. Samples that were sheared with an extruder were found to have the same average particle diameters and an additional minority average particle diameter of about 40 μm. Without being bound to any specific theory it is hypothesized that the growth of the 20 μm and 40 μm particle size materials is a feature of the delamination of the clay material, the growth of copper sulfur materials on step edges, and the agglomeration of the exposed clay faces on or about the charged copper sulfur phases.

Yet another important aspect of the methods described herein is the irreversible binding of mercury from the flue gas stream to the mercury sorbent materials produced by the methods described herein. Herein, irreversible binding means that the sequestered mercury is not leached from the mercury sorbent material by water or solvents that are primarily water (where “primarily water” means not less than 75 wt. % water).

In other aspects of the methods described herein, other materials may be added to the materials used in the methods described in U.S. Pat. No. 8,268,744. The additives to the methods may be used individually or in combination. In an aspect of the methods described herein, alternatives to the clay material described in U.S. Pat. No. 8,268,744 may be used. The alternatives to the clay material may be used individually, or in combination. The additives and the alternatives to the clay material may be used in combination. These additives to the methods, alternatives to the clay material, and combinations thereof may improve the processing, may improve the thermal stability of the material produced, or both improve processing and thermal stability of the material produced. The copper covellite and excess sulfide are subject to oxidation and as noted above, copper may form covellite in the presence of sulfur. The addition of single or multiple dry materials to a mechanical shearing apparatus can be by any means available to one of ordinary skill in the art.

To reduce oxidation during the manufacturing process, during storage, during use, or a combination thereof, a magnesium based layered silicate may be used as an alternative to the clay material, or as an additive to the clay material in the methods described herein. Hectorite may be used as the clay material, either instead of or in addition to, one or more of the clay materials described above. Talc, chloritic talc, chlorite clay, or any combination of talc, chloritic talc, and chlorite clay may be used instead of or in addition to one or more of the clay materials described above. If hectorite, talc, chloritic talc, chlorite clay, or any combination thereof is used in addition to the (other) clay material, the weight ratio of hectorite, talc, chloritic talc, chlorite clay, or any combination thereof to the (other) clay material may be from about 1:99 to about 99:1, preferably about 1:19 to about 19:1, and more preferably about 1:9 to about 9:1. If hectorite, talc, chloritic talc, chlorite clay, or any combination thereof is used, it may be added separately to the mechanical shearing apparatus, or it may be added to or pre-blended with all or a part of the (other) clay material, if present, prior to the pre-blend being added to the mechanical shearing apparatus. Alternatively, the hectorite, talc, chloritic talc, chlorite clay, or any combination thereof may be added to or pre-blended with the copper source, the sulfur source, or both the copper and sulfur sources, either individually or in combination, prior to being added to the mechanical shearing apparatus. The hectorite, talc, chloritic talc, chlorite clay, or any combination thereof may be added to the mechanical shearing apparatus by any combination of the previously described methods. Without being bound to any specific theory it is hypothesized that the use of magnesium based layer silicate improves the shelf stability (stability during storage).

Inorganic and polymeric dispersant agents may be used as additives, either individually or in combination, to the materials used in the methods as processing aids for clay dispersion, for reducing covellite crystallinity, or for a combination thereof. Non-limiting examples of dispersant agents include tetrasodium pyrophosphate, sodium silicate (with other performance function as well), sodium polyacrylates, and sodium polyaspartate of low, medium, and/or high weight average molecular weight. For polyaspartates a “low” weight average molecular weight, M_{w}, is <3000 g/mol, for “medium M_{w},” 3,000 to 10,000 g/mol, and for “high” M_{w}, M_{w} >10,000 g/mol. Some dispersants, such as, without limitation, sodium silicate may also perform another function in addition to acting as a dispersant. The weight percent of the dispersant used may range from about 0.1 wt. % to about 10 wt. % of the product produced, and preferably from about 1 wt. % to about 5 wt. % of the product produced. The dispersant may be separately added to the mechanical shearing apparatus, it may be added to or pre-blended with, either individually or in combination, one or more of the other materials before being added to the mechanical shearing apparatus, it may be dispersed in, dissolved in, or a combination of dispersed in and dissolved in the water, solvent, or combination of water and solvent before being added to the mechanical shearing apparatus, or any combination thereof. The phrase “A may blended, either individually or in combination, with one or more materials” means, if the other materials are B and C, that A may be blended with B to form an AB pre-blend, A may be blended with C to form an AC pre-blend, A may be blended with B and C to form an ABC pre-blend, or some A may be blended with B to form an AB pre-blend and some A may be blended with C to form an AC pre-blend where the blends with B and/or C may use all or a portion of materials B, and/or all or a portion of C. Without being bound to any specific theory it is hypothesized that the use of a dispersant to disperse the clay limits the agglomeration of the clay, and thus enhances the cation exchange, which it is believed disrupts and/or limits the standard reaction pathways. Without being bound to any specific theory it is hypothesized that the use of a dispersant reduces covellite crystallinity by absorbing to the surface of any covellite formed, thus disrupting the formation of the crystal lattice.

Without being bound to any specific theory it is hypothesized that oxidation of the copper sulfide/covellite formation during the manufacturing, during storage, during use, or any combination thereof may be reduced by adding pH stabilizing agents, oxygen scavengers (antioxidants), moisture scavengers, or any combination thereof to the materials used in the methods described herein. Non-limiting examples of pH stabilizing agents that may be used as additives, individually or in combination, include sodium carbonate, sodium bicarbonate, lime (CaO), hydrated lime, trona (trisodium hydrogen-dicarbonate dihydrate, also known as sodium sesquicarbonate, or Na₃(CO₃)(HCO₃)·2H₂O), calcium carbonate (calcite), and calcium magnesium carbonate (dolomite). The weight percent of the pH stabilizing agent used may range from about 0.1 wt. % to about 50 wt. % of the product produced, and preferably from about 1 wt. % to about 20 wt. % of the product produced, and in some embodiments, from 5 wt. % to 20 wt. % or 10 wt. % to 20 wt. % of the product produced. In some embodiments, the weight percent of the pH stabilizing agent that is added is an amount sufficient to maintain the pH of the material in the extruder, the pH of the material in the mixer, and/or the pH of the final product above neutral pH (pH=7), and preferably in the range of about pH 9 to about pH 11, and it is expected that the sufficient amount may be in the range of 0.1 wt. % to about 50 wt. % of the product produced. In some embodiments, the substrate, such as, but not limited to, the silicate clay material, incorporates one or more of the above pH stabilizing materials, and in those embodiments, the weight percent of the pH stabilizing added (in addition to that already present in the clay, substrate, or other material not specifically added for pH effects) may range from about 0.1 wt. % to about 50 wt. % of the product produced, and preferably from about 1 wt. % to about 20 wt. % of the product produced, and in some embodiments, from 5 wt. % to 20 wt. % or 10 wt. % to 20 wt. % of the product produced. The pH stabilizing agent may be separately added to the mechanical shearing apparatus, it may be added to or pre-blended with, either individually or in combination, one or more of the other materials, before being added to the mechanical shearing apparatus, or any combination thereof. In some embodiments, the pH stabilizing agent is added to the water that is added to the extruder, although this is not the preferred manner of addition. In some embodiments, the pH stabilizing agent may be blended with the milled or sized particles after extrusion and drying, and/or blended with an intermediate (post-extrusion), such as prior to milling/sizing. In some embodiments, from about 0.001 wt. % to about 10 wt. % of the final product is a pH stabilizing agent added to the milled/sized particles, to an intermediate (post-extrusion), or a combination of addition to an intermediate and milled/sized particles. In some embodiments, the substrate, such as a silicate clay material, is selected to be one which incorporates one or more pH stabilizing agents, such as, and without limitation, at least 3 wt. %, at least 5 wt. %, at least 7.5 wt. %, or at least 10 wt. % of one or more of the pH stabilizing agents described above. In some embodiments, a combination of the above are used to add the pH stabilizing agent.

Non-limiting examples of oxygen scavengers that may be used as additives, either individually or in combination, include sodium bisulfite, and butylated hydroxytoluene, and similar chemicals that can react with radicals or oxygen. The weight percent of the oxygen scavenger used may range from about 0.001 wt. % to about 10 wt. % of the product produced, and preferably from about 1 wt. % to about 3 wt. % of the product produced. The oxygen scavenger may be separately added to the mechanical shearing apparatus, it may be added to or pre-blended with, either individually or in combination, one or more of the other materials before being added to the mechanical shearing apparatus, it may be dispersed in, dissolved in, or a combination of dispersed in and dissolved in the water, solvent, or combination of water and solvent before being added to the mechanical shearing apparatus, it may be blended with the intermediate produced after drying and before milling, it may be blended with the product after milling, or any combination thereof.

Non-limiting examples of moisture scavengers include calcium sulfate, calcium oxide, and calcium hydroxide. The weight percent of the moisture scavenger used may range from about 0.001 wt. % to 15 about wt. % of the product produced, and preferably from about 0.5 wt. % to about 5 wt. % of the product produced. The moisture scavenger may be separately added to the mechanical shearing apparatus, it may be added to or pre-blended with, either individually or in combination, one or more of the other materials added to the mechanical shearing apparatus, it may be added to or blended with the intermediate produced during the method after drying and before milling, it may be added to or blended with the product after milling, or any combination thereof.

In other aspects of the methods described herein, other sources of sulfur may be used, individually or in combination, instead of or in addition to, those described above. Non-limiting examples of these other sulfur sources, which may be used individually or in combination, include elemental sulfur, sodium trithiocarbonate, silane with thiol functionality (a non-limiting example is gamma mercaptopropylmethoxy silane), sodium dimethyl-dithiocarbamate, and sodium salt of trimecapto-s-triazine. The total ratio of sulfur in the final product is adjusted such that the ratio of copper ion to sulfide ion is in one of the ranges described above, or up to 20 wt. % excess of sulfur may be used. In some embodiments, the weight ratio of the other sulfur source (those described in this paragraph) to the standard sulfur source (those described before this paragraph) may range from 1:100 to 100:1, and preferably is in the range of 1:5 to 5:1. If the sulfur is used in addition to another source of sulfur, it may be separately added to the mechanical shearing apparatus, it may be added to or pre-blended with, either individually or in combination, one or more of the other materials before being added to the mechanical shearing apparatus (but preferably not the copper source in the absence of any other materials), or any combination thereof. Without being bound to any specific theory it is hypothesized that covellite formation during the manufacturing, during storage, during use, or any combination thereof may become more complete and stable by substituting, or adding sulfur from one of the alternative sulfur sources.

In other aspects of the methods described herein, higher surface area substrates may be utilized instead of or in addition to the clay material described above. The higher surface area substrates may be used individually or in combination. Non-limiting examples of these higher surface area substrates, some of which may be listed among the clay materials above, include zeolite, atapulgite, sepiolite clay, imogolite clay, halloysite clay, perlite, vermiculite clay, fumed silica, lignite, and bleaching earth clay. If one or more of the higher surface area substrates are used in addition to the other clay material, the weight ratio of the sum of the higher surface area substrates to the clay material may be from about 1:99 to about 99:1, preferably about 1:19 to about 19:1, and more preferably about 1:9 to about 9:1. The specific surface area, as determined by standard BET surface area analysis using nitrogen gas, of the clay materials disclosed in U.S. Pat. No. 8,268,744 ranges from about 1 to about 700 m²/g, while the range of the specific surface area of the higher surface area substrates ranges from about 5 to about 1000 m²/g. In some embodiments, the amount of the higher surface area substrate added to the clay material is sufficient to result in a specific surface area for the combination that is at least 20% higher than, at least 30% higher than, or at least 50% higher than the specific surface area of the clay material alone. The higher surface area substrate may be added separately to the mechanical shearing apparatus, or it may be added to or pre-blended with all or a part of the clay material, if present, prior to the pre-blend or combination being added to the mechanical shearing apparatus. Alternatively, the higher surface area substrate may be added to or pre-blended with the copper source, the sulfur source, or both the copper and sulfur sources, either individually or in combination, prior to being added to the mechanical shearing apparatus. The higher surface area substrate may be added to the mechanical shearing apparatus by any combination of the previously described methods. Without being bound to any specific theory it is hypothesized that the use of higher surface area allows for more reaction sites and quicker reaction times.

In other aspects of the methods described herein, higher surface area of the clay material may be obtained by intercalation reagents which increases the inter-silicate spacing. FIG. 2 illustrates the in the inter-silicate-layer spacing. Intercalation reagents increase the spacing by diffusing into the inter-silicate-layer and increasing the distance between the silicate layers. Non-limiting examples of intercalation reagents, which may be used individually or in combination, include tetramethylammonium chloride, tetrabutylammonium chloride, trimethylcetylammonium chloride, and tetraethoxysilane. The weight percent of the intercalation reagent used may range from about 0.001 wt. % to about 15 wt. % of the product produced, and preferably from about 0.5 wt. % to about 5 wt. % of the product produced. The intercalation reagent may be separately added to the mechanical shearing apparatus, it may be added to or pre-blended with, either individually or in combination, one or more of the other materials added to the mechanical shearing apparatus, it may be dispersed in, dissolved in, or a combination of dispersed in and dissolved in the water, solvent, or combination of water and solvent before being added to the mechanical shearing apparatus, or any combination thereof. In preferred embodiments, the intercalation reagent is added to or blended with the clay prior to the clay/intercalation blend being added to the mechanical shearing apparatus. Without being bound to any specific theory, it is hypothesized that the use of Intercalation reagents provides accessibility to more reaction sites and faster diffusion to the sites. In those embodiments in which an intercalation reagent is used, the interlayer d(001)-spacing may not be less than 12 Å when the mercury sorbent material produced by the method contains less than about 4 wt. % water.

In those aspects of the invention using blending or pre-blending, geometric blending may be used if one component of the blend is much smaller (as a non-limiting example, less than 10 wt. % or less than 5 wt. %) than the other component(s) of the blend.

In other aspects of the methods described herein, the modifications to the methods of U.S. Pat. No. 8,268,744 as described herein may be used in combination. As a non-limiting example, at least a portion of the clay material may be replaced with a higher surface area substrate and in addition one or more additives may be used during the processing. Any combination of the above described modifications may be used.

Embodiments of the present invention also include products produced by the method describe herein, and products formed from a phyllosilicate, a sulfur source, and a copper source, and including at least one member of the group consisting of the additives described herein, alternative clay materials described herein, and alternative sulfur sources described herein. In some embodiments of the present invention, is a mercury sorbent material comprising a clay, a copper source and a sulfur source, wherein the powder X-ray diffraction pattern of the product being substantially free of a peak at 2.73±0.1 Å.

Without being bound to any specific theory it is hypothesized that the product of the methods described herein, and/or the product formed by including the additives described herein, using the alternative clay material, using the alternative sulfur sources, or any combination thereof, are of the same thermal stability or improved thermal stability compared to products produced by the methods described in U.S. Pat. No. 8,268,744. The thermal stability of the products is measured by a color change. As described in the examples below, the mercury sorbent particles, such as those produced by the methods described herein, may be pressed into a pellet under appropriate pressure, such as, but not limited to, 200 psi (gauge) pressure, and the resultant pellet may be measured using a colorimeter such as but not limited to a LabScan XE™ instrument (Hunter Association Laboratory Inc). Measurements are taken soon after manufacture (such as, without limitation, within 1 week, within 48 hours, or within 24 hours of manufacture), and measurements are taken at subsequent times under laboratory controlled conditions. In some embodiments, the products produced by the methods described herein, and products formed from a phyllo silicate, a sulfur source, and a copper source, and including at least one member of the group consisting of the additives described herein, alternative clay materials described herein, and alternative sulfur sources described herein, may exhibit a change in the Hunter L or CIE L*value of not more than 5, not more than 4, not more than 3, or not more than 2 after 28 days at about 25 ° C. with a relative humidity (rh) in the range of 20% to 50%. In some embodiments, the products produced by the methods described herein, and products formed from a phyllosilicate, a sulfur source, and a copper source, and including at least one member of the group consisting of the additives described herein, alternative clay materials described herein, and alternative sulfur sources described herein, may exhibit a change in the Hunter L value of not more than 3, not more than 2.5, not more than 2, or not more than 1.5 after 4 days (96 hours) at about 100 ° C. with a relative humidity (rh) in the range of 20% to 50%. In some embodiments, the products produced by the methods described herein, and products formed from a phyllosilicate, a sulfur source, and a copper source, and including at least one member of the group consisting of the additives described herein, alternative clay materials described herein, and alternative sulfur sources described herein, may exhibit a change in the Hunter L value of not more than 3, not more than 2.5, not more than 2, or not more than 1.5 after 24 hours at about 160 ° C. with a relative humidity (rh) in the range of about 20% to about 50%.

The mercury sorbent material resulting from the methods described herein and a mercury sorbent material formed from a phyllosilicate, a sulfur source, and a copper source, and including at least one member of the group consisting of the additives described herein, alternative clay materials described herein, and alternative sulfur sources described herein, may be retained in a fly ash waste stream. While activated carbon containing fly ash can be detrimental to concrete formation and stability, mercury sorbent material containing fly ash is preferably not detrimental to the formation and/or stability of concrete. Preferably, the mercury sorbent material does not increase the amount of an air-entrainment agent (AEA) necessary for the formation of concrete, one measure of which is a Foam Index test value. More preferably, the mercury sorbent material does not adsorb or react with the AEA, even more preferably the mercury sorbent materials aids the AEA in forming stable 10 to 250 μm pockets within the finished concrete. Moreover, the sorbed (sequestered) mercury preferably does not leach from the mercury sorbent material during or after the concrete formation process. Additionally, the inclusion of the mercury sorbent material preferably inhibits the degradation of concrete. Methods of inhibiting degradation of concrete include limiting and/or preventing the alkali silicate reaction, carbonation, sulfate attack, leaching, and/or structural damage from freeze/thaw cycling. Without being bound to any particular theory, products produced by the method describe herein, and products formed from a phyllosilicate, a sulfur source, and a copper source, and including at least one member of the group consisting of the additives described herein, alternative clay materials described herein, and alternative sulfur sources described herein, preferably inhibits the degradation of concrete though water adsorption and limited expansion thereby improving the freeze/thaw cycling of the concrete and/or through prevention of ion leaching. An additional benefit of the herein described materials is the similarity in bulk structure to cement, silicate-aluminate materials, preferably supporting chemical binding of the mercury sorbent material into prepared concrete.

Mercury sorbents can be tested and evaluated for their performance under different conditions:

A laboratory bench scale test uses nitrogen, air or simulated flue gas, and typically the sorbent is placed in a fixed bed. The simulated flue gas has a composition of SO₂, NOₓ, HCl, CO₂, O₂, H₂O and Hg⁰ under an elevated temperature. The gas is passed through the sorbent bed at a certain flow rate. The effluent gas is analyzed for its mercury concentration by a mercury analyzer. The test is allowed to proceed until adsorption equilibrium has been reached. Both the mercury removal efficacy and sorption capacity can be determined at the end of the test. The factors having an influence on the results are temperature, oxidation state of mercury and composition of the flue gas. The bench scale test is a very economical way to screen sorbents.

A pilot scale test is very effective to study sorbent performance under conditions close to the true industrial conditions. The test unit is normally set-up for an in-flight test. The simulated flue gas, or a slip stream flue gas can be extracted from an industrial facility, such as a power plant's ESP (electrostatic precipitator) or a fabric filter unit can be used to house the sorbent. The sorbent is injected into the test system and the mercury concentration is monitored for the mercury concentration change. The contact time between sorbent and flue gas need be only a few seconds.

Lastly, a full scale power plant test can be arranged. The design and selection of injection systems and rapid and accurate measurement of mercury concentration are important factors during the evaluation period.

Some non-limiting embodiments of the invention are:

Embodiment 1: A method of manufacturing a mercury sorbent material including but not limited to:
adding mercury sorbent components, optionally made into a mercury sorbent pre-mixture, to a shearing apparatus, where the mercury sorbent components include, but are not limited to:
   a first dry clay, a second dry clay, or a combination of a first dry clay and a second dry clay;
   a dry copper source; and
   a first dry sulfur source, a second dry sulfur source, or a combination of a first dry sulfur source and a second dry sulfur source;
and forming the mercury sorbent material by shearing the mercury sorbent components using the shearing apparatus;
wherein at least one member of the group of conditions (a), (b), and (c) applies, and the conditions are:
   condition (a) the mercury sorbent material also comprises an additive;
   condition (b) the second dry clay is present;
   condition (c) the second dry sulfur source is present;
and
wherein a powder X-ray diffraction pattern of the mercury sorbent material is substantially free of a diffraction peak at 2.73±0.01 Å.

Embodiment 2: In some embodiments, such as but not limited to the method of embodiment 1, the mercury sorbent pre-mixture is made and making the mercury sorbent pre-mixture includes but is not limited to:

making a copper/clay mixture by admixing a dry clay and a dry copper source;

making a sulfur/clay mixture by admixing a dry clay and a dry sulfur source;

and admixing the copper/clay mixture and the sulfur/clay mixture to form the mercury sorbent pre-mixture.

Embodiment 3: In some embodiments, such as but not limited to the method of embodiment 1, the mercury sorbent pre-mixture is made and making the mercury sorbent pre-mixture comprises: admixing the copper/clay mixture and the sulfur/clay mixture to form the mercury sorbent pre-mixture.

Embodiment 4: In some embodiments, such as but not limited to the methods of embodiments 1-3, the clay has less than about 15% by weight water.

Embodiment 5: In some embodiments, such as but not limited to the methods of embodiments 1-4, shearing is accomplished by passing the mercury sorbent components or pre-mixture through an extruder and wherein the method further comprises adding water to the mercury sorbent components or pre-mixture such that the extruded pre-mixture or extruded components have about 15% to about 40% by weight water.

Embodiment 6: In some embodiments, such as but not limited to the methods of embodiments 1-4, shearing is accomplished by passing the mercury sorbent components or pre-mixture through a pin mixer and wherein the method further comprises adding water to the mercury sorbent components or pre-mixture such that when mixed in the pin mixer, the pre-mixture or components contain about 15% to about 40% weight water.

Embodiment 7: In some embodiments, such as but not limited to the methods of embodiments 1-6, the mercury sorbent material includes a pH stabilizing agent.

Embodiment 8: In some embodiments, such as but not limited to the method of embodiment 7, the pH stabilizing agent is added to one or more of the mercury sorbent components, to the shearing apparatus, to the mercury sorbent material after shearing, to the mercury sorbent material after optionally being dried after shearing, or any combination thereof.

Embodiment 9: In some embodiments, such as but not limited to the methods of embodiments 7 and 8, the pH stabilizing agent is sodium carbonate, sodium bicarbonate, lime (CaO), hydrated lime, trona (trisodium hydrogen-dicarbonate dihydrate), calcium carbonate (calcite), calcium magnesium carbonate (dolomite), or a combination thereof.

Embodiment 10: In some embodiments, such as but not limited to the methods of embodiments 7-9, the mercury sorbent material produced includes 0.1 wt. % to 50 wt. % of the pH stabilizing agent when the water or solvent content of the material is not more than 5 wt. %.

Embodiment 11: In some embodiments, such as but not limited to the methods of embodiments 7-9, the mercury sorbent material produced includes 1 wt. % to 20 wt. % of the pH stabilizing agent when the water or solvent content of the material is not more than 5 wt. %.

Embodiment 12: In some embodiments, such as but not limited to the methods of embodiments 7-9, the mercury sorbent material produced includes 10 wt. % to 20 wt. % of the pH stabilizing agent when the water or solvent content of the material is not more than 5 wt. %.

Embodiment 13: In some embodiments, such as but not limited to the methods of embodiments 1-12, the first dry clay is present ant the first dry clay includes, but is not limited to, a phyllo silicate selected from the group consisting of bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and mixtures thereof.

Embodiment 14: In some embodiments, such as but not limited to the method of embodiment 13, the first dry clay is present ant the first dry clay includes, but is not limited to, a montmorillonite.

Embodiment 15: In some embodiments, such as but not limited to the methods of embodiments 1-14, the dry copper source includes a copper salt selected from the group consisting of anhydrous copper compounds selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof; and/or a copper compound hydrate where the copper compound of the hydrate is selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof.

Embodiment 16: In some embodiments, such as but not limited to the methods of embodiments 1-15, the first dry sulfur source is present, and the first dry sulfur source includes but is not limited to a sulfur salt selected from the group consisting of sodium sulfide, sodium sulfide trihydrate, sodium sulfide nonahydrate, sodium disulfide, sodium polysulfide, ammonium sulfide, ammonium disulfide, ammodium polysulfide, potassium sulfide, potassium disulfide, potassium polysulfide, calcium polysulfide, hydrogen sulfide, hydrogen disulfide, aluminum sulfide, magnesium sulfide, thiolacetic acid, thiobenzoic acid, and mixtures thereof.

Embodiment 17: In some embodiments, such as but not limited to the methods of embodiments 1-12, the first clay is present and the first clay is sodium bentonite, the copper source is copper sulfate pentahydrate, and the first dry sulfur source is present and is sodium sulfide trihydrate.

Embodiment 18: In some embodiments, such as but not limited to the methods of embodiments 1-17, the second clay is present.

Embodiment 19: In some embodiments, such as but not limited to the method of embodiment 18, the second clay is selected from the group consisting of hectorite, talc, chloritic talc, chlorite clay, zeolite, atapulgite, sepiolite clay, imogolite clay, halloysite clay, perlite, vermiculite clay, fumed silica, lignite, bleaching earth clay, and combinations thereof.

Embodiment 20: In some embodiments, such as but not limited to the methods of embodiments 18 and 19, the first dry clay source and the second dry clay source are present.

Embodiment 21: In some embodiments, such as but not limited to the method of embodiment 20, the ratio of the weight the second dry clay to the weight of the first dry clay is in the range of 1:99 to 99:1.

Embodiment 22: In some embodiments, such as but not limited to the method of embodiment 20, the ratio of the weight the second dry clay to the weight of the first dry clay is in the range of 1:19 to 19:1.

Embodiment 23: In some embodiments, such as but not limited to the method of embodiment 20, the ratio of the weight the second dry clay to the weight of the first dry clay is in the range of 1:9 to 9:1.

Embodiment 24: In some embodiments, such as but not limited to the methods of embodiments 1-23, the second dry sulfur source is present.

Embodiment 25: In some embodiments, such as but not limited to the method of embodiment 24, the second dry sulfur source is selected from the group consisting of elemental sulfur, sodium trithiocarbonate, silane with thiol functionality, sodium dimethyl-dithiocarbamate, sodium salt of trimecapto-s-triazine, and combinations thereof.

Embodiment 26: In some embodiments, such as but not limited to the methods of embodiments 24 and 25, the first dry sulfur source and the second dry sulfur source are present.

Embodiment 27: In some embodiments, such as but not limited to the method of embodiment 26, the mercury sorbent material produced comprises a weight ratio of the second dry sulfur source to the first dry sulfur source in the range of 0.01:1 to 1:1.

Embodiment 28: In some embodiments, such as but not limited to the method of embodiment 26, the mercury sorbent material produced comprises a weight ratio of the second dry sulfur source to the first dry sulfur source in the range of 0.01:1 to 1:1.

Embodiment 29: In some embodiments, such as but not limited to the methods of embodiments 1-28, a dispersant additive is present.

Embodiment 30: In some embodiments, such as but not limited to the method of embodiment 29, the dispersant additive is selected from the group consisting of tetrasodium pyrophosphate, sodium silicate, sodium polyacrylates, and low molecular weight (M_{w}<3000 g/mol) sodium polyaspartates, medium molecular weight (M_{w} is 3000 to 10,000 g/mol) polyaspartates, high medium molecular weight (M_{w}>10,000 g/mol) polyaspartates, and combinations thereof.

Embodiment 31: In some embodiments, such as but not limited to the methods of embodiments 29 and 30, the mercury sorbent material produced comprises 0.1 wt. % to 10 wt. % of the dispersant additive when the water or solvent content of the material is not more than 5 wt. %.

Embodiment 32: In some embodiments, such as but not limited to the methods of embodiments 29 and 30, the mercury sorbent material produced comprises 1 wt. % to 5 wt. % of the dispersant additive when the water or solvent content of the material is not more than 5 wt. %.

Embodiment 33: In some embodiments, such as but not limited to the methods of embodiments 29-32, the dispersant additive is added to one or more of the mercury sorbent components, to the shearing apparatus, to the mercury sorbent material after shearing, to the mercury sorbent material after optionally being dried after shearing, or any combination thereof.

Embodiment 34: In some embodiments, such as but not limited to the methods of embodiments 1-33, an oxygen scavenger additive is present.

Embodiment 35: In some embodiments, such as but not limited to the method of embodiment 34, the oxygen scavenger additive is sodium bisulfite, butylated hydroxytoluene, or a combination thereof.

Embodiment 36: In some embodiments, such as but not limited to the methods of embodiments 34 and 35, the mercury sorbent material produced comprises 0.001 wt. % to 10 wt. % of the oxygen scavenger additive when the water or solvent content of the material is not more than 5 wt. %.

Embodiment 37: In some embodiments, such as but not limited to the methods of embodiments 34-36, the oxygen scavenger additive is to one or more of the mercury sorbent components, to the shearing apparatus, to the mercury sorbent material after shearing, to the mercury sorbent material after optionally being dried after shearing, or any combination thereof.

Embodiment 38: In some embodiments, such as but not limited to the methods of embodiments 1-37, a moisture scavenger additive is present.

Embodiment 39: In some embodiments, such as but not limited to the method of embodiment 38, the moisture scavenger additive is calcium sulfate, calcium oxide, calcium hydroxide, or a combination thereof.

Embodiment 40: In some embodiments, such as but not limited to the methods of embodiments 38 and 39, the mercury sorbent material produced comprises 0.001 wt. % to 15 wt. % of the moisture scavenger additive when the water or solvent content of the material is not more than 5 wt. %.

Embodiment 41: In some embodiments, such as but not limited to the methods of embodiments 38 and 39, the mercury sorbent material produced comprises 0.5 wt. % to 5 wt. % of the moisture scavenger additive when the water or solvent content of the material is not more than 5 wt. %.

Embodiment 42: In some embodiments, such as but not limited to the methods of embodiments 38-41, the moisture scavenger additive is to one or more of the mercury sorbent components, to the shearing apparatus, to the mercury sorbent material after shearing, to the mercury sorbent material after optionally being dried after shearing, or any combination thereof.

Embodiment 43: In some embodiments, such as but not limited to the methods of embodiments 1-42, an intercalation reagent additive is present.

Embodiment 44: In some embodiments, such as but not limited to the method of embodiment 43, the intercalation reagent additive is tetramethylammonium chloride, tetrabutylammonium chloride, trimethylcetylammonium chloride, tetraethoxysilane, or a combination thereof.

Embodiment 45: In some embodiments, such as but not limited to the methods of embodiments 43 and 44, the mercury sorbent material produced comprises 0.001 wt. % to 15 wt. % of the intercalation reagent additive when the water or solvent content of the material is not more than 5 wt. %.

Embodiment 46: In some embodiments, such as but not limited to the methods of embodiments 43 and 44, the mercury sorbent material produced comprises 0.5 wt. % to 5 wt. % of the intercalation reagent additive when the water or solvent content of the material is not more than 5 wt. %.

Embodiment 47: In some embodiments, such as but not limited to the methods of embodiments 43-46, the intercalation reagent additive is added to one or more of the mercury sorbent components, to the shearing apparatus, or any combination thereof.

Embodiment 48: A mercury sorbent material comprising a material that includes, but is not limited to:
a first clay, a second clay, or a combination of a first clay and a second clay;
a copper source; and
a first sulfur source, a second sulfur source, or a combination of a first and a second sulfur sources;
wherein condition (a) applies, condition (b) applies, condition (c) applies, or a combination thereof applies;
condition (a) the mercury sorbent material also comprises an additive;
condition (b) the second clay is present;
condition (c) the second sulfur source is present; and

wherein mercury sorbent material is substantially free of a clay/covellite composite as determined by powder X-ray diffraction, the powder X-ray diffraction pattern being substantially free of a peak at 2.73±0.1 Å.

Embodiment 49: In some embodiments, such as but not limited to the mercury sorbent material of embodiment 48, a molar ratio of copper to sulfur is less than 1.

Embodiment 50: In some embodiments, such as but not limited to the mercury sorbent material of embodiment 49, the molar ratio is less than 0.5.

Embodiment 51: In some embodiments, such as but not limited to the mercury sorbent material of embodiment 48, a molar ratio of copper to sulfur is greater than 1.

Embodiment 52: In some embodiments, such as but not limited to the mercury sorbent material of embodiment 51, the ratio greater than 2.

Embodiment 53: In some embodiments, such as but not limited to the mercury sorbent materials of embodiments 48-52, the mercury sorbent material includes a pH stabilizing agent.

Embodiment 54: In some embodiments, such as but not limited to the mercury sorbent material of embodiment 53, the pH stabilizing agent is sodium carbonate, sodium bicarbonate, lime (CaO), hydrated lime, trona (trisodium hydrogen-dicarbonate dihydrate), calcium carbonate (calcite), calcium magnesium carbonate (dolomite), or a combination thereof.

Embodiment 55: In some embodiments, such as but not limited to the mercury sorbent materials of embodiments 53 and 54, the mercury sorbent material produced includes 0.1 wt. % to 50 wt. % of the pH stabilizing agent when the water or solvent content of the material is not more than 5 wt. %.

Embodiment 56: In some embodiments, such as but not limited to the mercury sorbent materials of embodiments 53 and 54, the mercury sorbent material produced includes 1 wt. % to 20 wt. % of the pH stabilizing agent when the water or solvent content of the material is not more than 5 wt. %.

Embodiment 57: In some embodiments, such as but not limited to the mercury sorbent materials of embodiments 53 and 54, the mercury sorbent material produced includes 10 wt. % to 20 wt. % of the pH stabilizing agent when the water or solvent content of the material is not more than 5 wt. %.

Embodiment 58: In some embodiments, such as but not limited to the mercury sorbent materials of embodiments 48-57, the first clay is present and the first clay comprises a phyllosilicate selected from the group consisting of bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and mixtures thereof.

Embodiment 59: In some embodiments, such as but not limited to the mercury sorbent material of embodiment 58, the first clay includes a montmorillonite.

Embodiment 60: In some embodiments, such as but not limited to the mercury sorbent materials of embodiments 48-59, the dry copper source includes a copper salt selected from the group consisting of anhydrous copper compounds selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof and/or a copper compound hydrates where the copper compound of the copper compound hydrate is selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof.

Embodiment 61: In some embodiments, such as but not limited to the mercury sorbent materials of embodiments 48-60, the first sulfur source is present, and the first sulfur source comprises a sulfur salt selected from the group consisting of sodium sulfide, sodium sulfide trihydrate, sodium sulfide nonahydrate, sodium disulfide, sodium polysulfide, ammonium sulfide, ammonium disulfide, ammodium polysulfide, potassium sulfide, potassium disulfide, potassium polysulfide, calcium polysulfide, hydrogen sulfide, hydrogen disulfide, aluminum sulfide, magnesium sulfide, thiolacetic acid, thiobenzoic acid, and mixtures thereof.

Embodiment 62: In some embodiments, such as but not limited to the mercury sorbent materials of embodiments 48-61, the second clay is present.

Embodiment 63: In some embodiments, such as but not limited to the mercury sorbent material of embodiment 62, the second clay is selected from the group consisting of hectorite, talc, chloritic talc, chlorite clay, zeolite, atapulgite, sepiolite clay, imogolite clay, halloysite clay, perlite, vermiculite clay, fumed silica, lignite, bleaching earth clay, and combinations thereof.

Embodiment 64: In some embodiments, such as but not limited to the mercury sorbent materials of embodiments 62 and 63, the first clay source and the second clay source are present.

Embodiment 65: In some embodiments, such as but not limited to the mercury sorbent material of embodiment 64, the ratio of the weight the second clay to the weight of the first clay is in the range of 1:99 to 99:1.

Embodiment 66: In some embodiments, such as but not limited to the mercury sorbent material of embodiment 64, the ratio of the weight the second clay to the weight of the first clay is in the range of 1:19 to 19:1.

Embodiment 67: In some embodiments, such as but not limited to the mercury sorbent material of embodiment 64, the ratio of the weight the second clay to the weight of the first clay is in the range of 1:9 to 9:1.

Embodiment 68: In some embodiments, such as but not limited to the mercury sorbent materials of embodiments 48-67, the second sulfur source is present.

Embodiment 69: In some embodiments, such as but not limited to the mercury sorbent material of embodiment 68, the second sulfur source is selected from the group consisting of elemental sulfur, sodium trithiocarbonate, silane with thiol functionality, sodium dimethyl-dithiocarbamate, sodium salt of trimecapto-s-triazine, and combinations thereof.

Embodiment 70: In some embodiments, such as but not limited to the mercury sorbent materials of embodiments 68 and 69, the first sulfur source and the second sulfur source are present.

Embodiment 71: In some embodiments, such as but not limited to the mercury sorbent material of embodiment 70, the mercury sorbent material produced comprises a weight ratio of the second sulfur source to the first sulfur source in the range of 0.01:1 to 1:10.

Embodiment 72: In some embodiments, such as but not limited to the mercury sorbent material of embodiment 70, the mercury sorbent material produced comprises a weight ratio of the second sulfur source to the first sulfur source in the range of 0.05:1 to 1:1.

Embodiment 73: In some embodiments, such as but not limited to the mercury sorbent materials of embodiments 48-72, a dispersant additive is present.

Embodiment 74: In some embodiments, such as but not limited to the mercury sorbent material of embodiment 73, the dispersant additive is selected from the group consisting of tetrasodium pyrophosphate, sodium silicate, sodium polyacrylates, and low molecular weight (M_{w}<3000 g/mol) sodium polyaspartates, medium molecular weight (M_{w} is 3000 to 10,000 g/mol) polyaspartates, high medium molecular weight (M_{w}>10,000 g/mol) polyaspartates, and combinations thereof.

Embodiment 75: In some embodiments, such as but not limited to the mercury sorbent materials of embodiments 73 and 74, the mercury sorbent material produced comprises 0.1 wt. % to 10 wt. % of the dispersant additive when the water or solvent content of the material is not more than 5 wt. %.

Embodiment 76: In some embodiments, such as but not limited to the mercury sorbent materials of embodiments 73 and 74, the mercury sorbent material produced comprises 1 wt. % to 5 wt. % of the dispersant additive when the water or solvent content of the material is not more than 5 wt. %.

Embodiment 78: In some embodiments, such as but not limited to the mercury sorbent materials of embodiments 48-72, an oxygen scavenger additive is present.

Embodiment 79: In some embodiments, such as but not limited to the mercury sorbent material of embodiment 78, the oxygen scavenger additive is sodium bisulfite, butylated hydroxytoluene, or a combination thereof.

Embodiment 80: In some embodiments, such as but not limited to the mercury sorbent materials of embodiments 78 and 79, the mercury sorbent material produced comprises 0.001 wt. % to 10 wt. % of the oxygen scavenger additive when the water or solvent content of the material is not more than 5 wt. %.

Embodiment 81: In some embodiments, such as but not limited to the mercury sorbent materials of embodiments 48-80, a moisture scavenger additive is present.

Embodiment 82: In some embodiments, such as but not limited to the mercury sorbent material of embodiment 81, the moisture scavenger additive is calcium sulfate, calcium oxide, calcium hydroxide, or a combination thereof.

Embodiment 83: In some embodiments, such as but not limited to the mercury sorbent materials of embodiments 81 and 82, the mercury sorbent material produced comprises 0.001 wt. % to 15 wt. % of the moisture scavenger additive when the water or solvent content of the material is not more than 5 wt. %.

Embodiment 84: In some embodiments, such as but not limited to the mercury sorbent materials of embodiments 81 and 82, wherein the mercury sorbent material produced comprises 0.5 wt. % to 5 wt. % of the moisture scavenger additive when the water or solvent content of the material is not more than 5 wt. %.

Embodiment 85: In some embodiments, such as but not limited to the mercury sorbent materials of embodiments 48-84, an intercalation reagent additive is present.

Embodiment 86: In some embodiments, such as but not limited to the mercury sorbent material of embodiment 85, the intercalation reagent additive is tetramethylammonium chloride, tetrabutylammonium chloride, trimethylcetylammonium chloride, tetraethoxysilane, or a combination thereof.

Embodiment 87: In some embodiments, such as but not limited to the mercury sorbent materials of embodiments 85 and 86, the mercury sorbent material produced comprises 0.001 wt. % to 15 wt. % of the intercalation reagent additive when the water or solvent content of the material is not more than 5 wt. %.

Embodiment 88: In some embodiments, such as but not limited to the mercury sorbent materials of embodiments 85 and 86, the mercury sorbent material produced comprises 0.5 wt.

% to 5 wt. % of the intercalation reagent additive when the water or solvent content of the material is not more than 5 wt. %.

Embodiment 89: In some embodiments, such as but not limited to the mercury sorbent materials of embodiments 48-88, the change in the Hunter L value of the mercury sorbent material after 28 days at 25 ° C. (±3 ° C.) with a relative humidity (rh) in the range of 20% to 50% is not more than 5.

Embodiment 90: In some embodiments, such as but not limited to the mercury sorbent materials of embodiments 48-88, the change in the Hunter L value of the mercury sorbent material after 28 days at 25 ° C. (±3 ° C.) with a relative humidity (rh) in the range of 20% to 50% is not more than 4.

Embodiment 91: In some embodiments, such as but not limited to the mercury sorbent materials of embodiments 48-88, the change in the Hunter L value of the mercury sorbent material after 28 days at 25 ° C. (+3 ° C.) with a relative humidity (rh) in the range of 20% to 50% is not more than 3.

Embodiment 92: In some embodiments, such as but not limited to the mercury sorbent materials of embodiments 48-88, the change in the Hunter L value of the mercury sorbent material after 28 days at 25 ° C. (±3 ° C.) with a relative humidity (rh) in the range of 20% to 50% is not more than 2.

Embodiment 93: In some embodiments, such as but not limited to the mercury sorbent materials of embodiments 48-88, the change in the CIE L*value of the mercury sorbent material after 28 days at 25 ° C. (±3 ° C.) with a relative humidity (rh) in the range of 20% to 50% is not more than 5.

Embodiment 94: In some embodiments, such as but not limited to the mercury sorbent materials of embodiments 48-88, the change in the CIE L*value of the mercury sorbent material after 28 days at 25 ° C. (±3 ° C.) with a relative humidity (rh) in the range of 20% to 50% is not more than 4.

Embodiment 95: In some embodiments, such as but not limited to the mercury sorbent materials of embodiments 48-88, the change in the CIE L*value of the mercury sorbent material after 28 days at 25 ° C. (±3 ° C.) with a relative humidity (rh) in the range of 20% to 50% is not more than 3.

Embodiment 96: In some embodiments, such as but not limited to the mercury sorbent materials of embodiments 48-88, the change in the CIE L*value of the mercury sorbent material after 28 days at 25 ° C. (±3 ° C.) with a relative humidity (rh) in the range of 20% to 50% is not more than 2.

Embodiment 97: In some embodiments, such as but not limited to the mercury sorbent materials of embodiments 48-88, the change in the Hunter L value of the mercury sorbent material after 96 hours at 100 ° C. (±5 ° C.) with a relative humidity (rh) in the range of 20% to 50% is not more than 3.

Embodiment 98: In some embodiments, such as but not limited to the mercury sorbent materials of embodiments 48-88, the change in the Hunter L value of the mercury sorbent material after 96 hours at 100 ° C. (±5 ° C.) with a relative humidity (rh) in the range of 20% to 50% is not more than 2.5.

Embodiment 99: In some embodiments, such as but not limited to the mercury sorbent materials of embodiments 48-88, the change in the Hunter L value of the mercury sorbent material after 96 hours at 100 ° C. (±5 ° C.) with a relative humidity (rh) in the range of 20% to 50% is not more than 2.

Embodiment 100: In some embodiments, such as but not limited to the mercury sorbent materials of embodiments 48-88, the change in the Hunter L value of the mercury sorbent material after 96 hours at 100 ° C. (±5 ° C.) with a relative humidity (rh) in the range of 20% to 50% is not more than 1.5.

Embodiment 101: In some embodiments, such as but not limited to the mercury sorbent materials of embodiments 48-88, the change in the Hunter L value of the mercury sorbent material after 24 hours at 160 ° C. (±5 ° C.) with a relative humidity (rh) in the range of 20% to 50% is not more than 3.

Embodiment 102: In some embodiments, such as but not limited to the mercury sorbent materials of embodiments 48-88, the change in the Hunter L value of the mercury sorbent material after 24 hours at 160 ° C. (±5 ° C.) with a relative humidity (rh) in the range of 20% to 50% is not more than 2.5.

Embodiment 103: In some embodiments, such as but not limited to the mercury sorbent materials of embodiments 48-88, the change in the Hunter L value of the mercury sorbent material after 24 hours at 160 ° C. (±5 ° C.) with a relative humidity (rh) in the range of 20% to 50% is not more than 2.

Embodiment 104: In some embodiments, such as but not limited to the mercury sorbent materials of embodiments 48-88, the change in the Hunter L value of the mercury sorbent material after 24 hours at 160 ° C. (±5 ° C.) with a relative humidity (rh) in the range of 20% to 50% is not more than 1.5.

Embodiment 105: A method of reducing oxidation in the manufacture, during storage, during use, or any combination thereof of a mercury sorbent material comprising a material that comprises clay, copper, and sulfur, and is substantially free of a clay/covellite composite as determined by powder X-ray diffraction, the powder X-ray diffraction pattern being substantially free of a peak at 2.73±0.1 Å, the method comprising:

(a) adding a dispersant, an oxygen scavenger, a moisture scavenger, an intercalation reagent, or any combination thereof;

(b) substituting the clay or supplementing the clay with a second clay selected from the group consisting of talc, chloritic talc, chlorite clay, atapulgite, sepiolite clay, imogolite clay, halloysite clay, perlite, lignite, bleaching earth clay, and combinations thereof;

(c) substituting the sulfur source or supplementing the sulfur source with a second sulfur source selected from the group consisting of elemental sulfur, sodium trithiocarbonate, silane with thiol functionality, sodium dimethyl-dithiocarbamate, sodium salt of trimecapto-s-triazine, and combinations thereof;

or

any combination of (a), (b), and (c).

In the embodiments labeled 1-105 above, the term “added to one or more of the mercury sorbent components” encompasses adding the material to the pre-mixture if a pre-mixture is made as well as addition to any one or more of the mercury sorbent components.

### EXAMPLES

The following examples are provided to illustrate the invention, but are not intended to limit the scope thereof.

### Example 1 —Comparative

In the bowl of a KITCHENAID™ stand mixer, 368.5 g sodium bentonite (85% passing 325 mesh), 16.5 g sodium chloride (from United Salt Corporation, passing 20 mesh), 57.0 copper sulfate pentahydrate (Old Bridge Chemicals, Inc. passing 40 mesh), and 31.0 g sodium sulfide trishydrate (Chem One Ltd.) were admixed for 5 minutes. Then 74.0 g de-ionized water was added to the mixture and the mixture was stirred 5 minutes. The mercury sorbent mixture was then extruded three times using a laboratory-scale extruder with a die-plate. The extrudates were then oven-dried at 100 ° C. The dried extrudates were ground and resulting particles passing through a 325 mesh screen were collected. The final moisture content of this sample was approximately 2 wt. %.

### Example 2—Comparative

In the bowl of a KITCHENAID stand mixer, 232.0 g sodium bentonite, 26.4 g sodium chloride, 91.2 g copper sulfate pentahydrate, and 49.6 g sodium sulfide trishydrate were admixed for 5 minutes. Then 52.4 g de-ionized water was added to the mixture and the mixture was stirred 5 minutes. The mercury sorbent mixture was then extruded three times using a laboratory-scale extruder with a die-plate. The extrudates were then oven-dried at 70 ° C. The dried extrudates were ground and resulting particles passing through a 325 mesh screen were collected. The final moisture content of this sample was approximately 3.5 wt. %.

### Example 3—Comparative

A mercury sorbent mixture was prepared by admixing 2,060 lbs sodium bentonite, 92.2 lbs sodium chloride, 318.6 lbs copper sulfate pentahydrate, 173.3 lbs sodium sulfide trishydrate in the bowl of a paddle mixer. The mixture was combined for 20 minutes and then fed into a 5 inch READCO™ continuous processor (by Readco Manufacturing Inc.) at a feed rate of about 900 lb/hr. As the mercury sorbent mixture was fed into the processor, water was fed into the processor through a liquid injunction port (separate from the dry-mixture feed port) at about 0.35 gallon/minute. The extrudate was dried at about 100 ° C. and ground to reduce the particle size. The mercury sorbent materials was found to have an average particle size of about 5 to about 25 μm and a moisture content below 10 wt. %.

### Example 4—Comparative

A mercury sorbent mixture was prepared by admixing 700 lbs sodium bentonite, 31.3 lbs sodium chloride, 108.3 lbs copper sulfate pentahydrate, and 59.0 lbs sodium sulfide trishydrate in the bowl of a paddle mixer. The mixture was combined for 20 minutes and then fed into a 16″ pin mixer (Mars Mineral) at a feed rate of about 1,100 lb/hr. As the mercury sorbent mixture was fed into the pin mixer, water was fed into the processor through a liquid injunction port (separate from the dry-mixture feed port) at about 0.35 gallon/minute. The extrudate was dried at about 100 ° C., and ground to reduce the particle size. The mercury sorbent materials were found to have an average particle size of about 5 to about 25 μm and a moisture content below 10 wt. % .

### Example 5 (LH47 Lab Preparation Process)

In the bowl of a KITCHENAID stand mixer, 299.6 g of sodium bentonite powder (˜50% passing 325 mesh) and 14.0 g of sodium chloride was mixed for one minute, then 47.6 g of copper sulfate pentahydrate (Chem One Ltd, Fine 30 grade) was added and mixed for another minute, and 38.8 g of sodium sulfide trihydrate (Chem One Ltd.) was added and mixed for 5 minutes. 57.2 g of de-ionized water was added to the above dry mixture and mixed another minute. The mercury sorbent mixture was then extruded three times using a laboratory-scale extruder with a die-plate. The extrudates were then oven-dried at 70 ° C. for ˜18 hours. The dried extrudates were ground and resulting particles passing through a 325 mesh screen were collected. The final moisture content of this sample was below 5% by weight.

### Example 6 (LH57 Lab Preparation Process)

In the bowl of a KITCHENAID stand mixer, 240.0 g of sodium bentonite powder (˜50% passing 325 mesh) and 45.6 g of trona (Natronₓ Technologies, LLC) was mixed for one minute, then 64.0 g of copper sulfate pentahydrate (Chem One Ltd, Fine 30 grade) was added and mixed for another minute, and 50.4 g of sodium sulfide trihydrate (Chem One Ltd. Flake morphology) was added and mixed for 5 minutes. 39.6 g of de-ionized water was added to the above dry mixture and mixed another minute. The mercury sorbent mixture was then extruded three times using a laboratory-scale extruder with a die-plate. The extrudates were then oven-dried at 70 ° C. for ˜18 hours. The dried extrudates were ground and resulting particles passing through a 325 mesh screen were collected. The final moisture content of this sample was below 5% by weight.

### Example 7 (LH 47 Product Process)

1,872.5 lbs of sodium bentonite, 297.5 lbs of copper sulfate pentahydrate, 242.5 lbs of sodium sulfide trihydrate, and 87.5 lbs of sodium chloride at their hourly rates were simultaneously fed into the rotary continuous mixer (Munson Machinery Company, Inc.) and mixed thoroughly. The resulted dry mixture was immediately fed into a 15 inch Extrud-O-Mix™ Extrusion processer (Bepex International LLC) at a feed rate of about 2,500 lb/hr. As the mercury sorbent mixture was fed into the processor, water was fed into the processor through a liquid injection port at about 375 lb/hr. The extrudate was dried using a fluid bed dryer (Carrier), and further pulverized by a mill (Pulvocron™ by Bepex International LLC) into fine particles with particle size of about 5-15 μm in their Dv50 (volume average diameter) of the particle size distribution, and a moisture content below 5% by weight.

### Example 8 (LH57 Production Process)

1,500 lbs of sodium bentonite, 400 lbs of copper sulfate pentahydrate, 315 lbs of sodium sulfide trihydrate, and 285 lbs of trona at their hourly rates were simultaneously fed into the rotary continuous mixer (Munson Machinery Company, Inc.) and mixed thoroughly. The resulted dry mixture was immediately fed into a 15 inch Extrud-O-Mix Extrusion processer (Bepex International LLC) at a feed rate of about 2,500 lb/hr. As the mercury sorbent mixture was fed into the processor, water was fed into the processor through a liquid injection port at about 250 lb/hr. The extrudate was dried using a fluid bed dryer (Carrier), and further pulverized by a mill (Pulvocron™ by Bepex International LLC) into fine particles with particle size of about 5-15 μm in their Dv50 (volume-average diameter) of the particle size distribution, and a moisture content below 5% by weight.

### Example 9 (LF172, Sulfur Additive in LH57 Formulation, the Lab Preparation Process)

In the bowl of a KITCHENAID stand mixer, 240.0 g of sodium bentonite powder (˜50% passing 325 mesh) and 20.0 g of elemental sulfur (Harwick Standard Distribution Corporation, grade 104) was mixed for one minute, 45.6 g of trona (Natronₓ Techologies, LLC) was added and mixed for another minute, then 64.0 g of copper sulfate pentahydrate (Chem One Ltd, Fine 30 grade) was added and mixed for another minute, and 50.4 g of sodium sulfide trihydrate (Chem One Ltd. Flake morphology) were added and mixed for 5 minutes. 46.4 g of de-ionized water was added to the above dry mixture and mixed one minute. The mercury sorbent mixture was then extruded three times using a laboratory-scale extruder with a die-plate. The extrudates were then oven-dried at 70 ° C. for ˜18 hours. The dried extrudates were ground and resulting particles passing through a 325 mesh screen were collected. The final moisture content of this sample was below 5% by weight.

### Example 10 (15NVEX3 Manufacturing Production Process)

Three thousand lbs (3,000 lbs) of sodium bentonite and 273 lbs of elemental sulfur (InteGro, Inc.) was blended for 30 minutes using a ribbon blender to obtain a bentonite clay/sulfur pre-blend. 1,500 lbs of sodium bentonite/sulfur pre-blend, 400 lbs of copper sulfate pentahydrate, 315 lbs of sodium sulfide trihydrate, and 285 lbs of trona at their hourly rates were simultaneously fed into the rotary continuous mixer (Munson Machinery Company, Inc.) and mixed thoroughly. The resulted dry mixture was immediately fed into a 15 inch Extrud-O-Mix™ Extrusion processer (Bepex International LLC) at a feed rate of about 2,500 lb/hr. As the mercury sorbent mixture was fed into the processor, water was fed into the processor through a liquid injection port at about 250 lb/hr. The extrudate was dried using a fluid bed dryer (Carrier), and further pulverized by a mill (Pulvocron™ by Bepex International LLC) into fine particles with particle size of about 5-15 μm in their Dv50 of the particle size distribution and a moisture content below 5% by weight.

### Test Procedure pH Measurement

2.5 of mercury sorbent is dispersed in 47.5 g of deionized water using a 100 mL beaker and a magnetic stirrer with a mixing time of 5-minute. The pH of the resulting slurry is measured and reported using a laboratory pH meter.

### Test Procedure on Color Measurement

The mercury sorbent particles are pressed into a pellet under 200 psi pressure. The resulting pellet is measured using a LabScan XE™ instrument (Hunter Association Laboratory Inc). If not further noticed, the value of CIE L* is reported for the white-blackness property. In other cases, the value of Hunter L is reported for the same property.

### Test Procedure for Mercury Sorbent Stability @ Ambient Conditions

Mercury sorbent was stored under the laboratory conditions at the ambient temperature (18 ° C.-23 ° C.) for an extended period of time. The specimen was retrieved at the end of each period of time and measured for their chemical properties, such as moisture content, pH and color.

### Test Procedure for Mercury Sorbent Oven Stability

Mercury sorbent was kept in an oven at certain temperature (within about ±2 ° C.) for extended period of time, specimen was retrieved at the end of certain period and measured for their chemical properties, such as moisture content, pH and color.

### Data on Formulations with Ph Stabilization Reagents and Improvement on their Chemical Stabilities

LH 50, 51 and 52 were prepared the same as LH47 in Example 5 except sodium chloride was replaced by sodium carbonate, sodium bicarbonate, and quick lime, respectively.

TABLE 1
Formulations with pH stabilization reagents

| Parts by weight | LH47 | LH50 | LH51 | LH52 |
|---|---|---|---|---|
| bentonite | 74.0 | 74.9 | 74.9 | 74.9 |
| copper sulfate hydrated | 11.9 | 11.9 | 11.9 | 11.9 |
| sodium sulfide hydrated | 9.7 | 9.7 | 9.7 | 9.7 |
| sodium chloride | 3.5 | | | |
| sodium carbonate | | 3.5 | | |
| sodium bicarbonate | | | 3.5 | |
| quick lime (CaO) | | | | 3.5 |
| Total | 100.0 | 100.0 | 100.0 | 100.0 |

TABLE 2
Data on pH and color changes under lab storage conditions @
ambient temperature

| | % Moisture | pH | ΔpH | L-Hunter | ΔL |
|---|---|---|---|---|---|
| LH47 | | | | | |
| Initial | 3.09 | 6.53 | | 35.6 | |
| 7-day | 0.39 | 5.25 | −1.28 | 39.3 | 3.63 |
| 14-day | 0.42 | 5.69 | −0.84 | 40.1 | 4.46 |
| 21-day | 0.15 | 6.04 | −0.49 | 42.2 | 6.57 |
| 28-day | 0.35 | 5.46 | −1.07 | 43.9 | 8.27 |
| LH50 | | | LH50 | | |
| Initial | 4.7 | 10.54 | | 35.5 | |
| 7-day | 0.54 | 9.41 | −1.13 | 36.3 | 0.81 |
| 14-day | 0.82 | 9.48 | −1.06 | 36.6 | 1.08 |
| 21-day | 0.40 | 9.32 | −1.22 | 36.5 | 0.95 |
| 28-day | 0.69 | 8.48 | −2.06 | 37.3 | 1.72 |
| LH51 | | | LH51 | | |
| Initial | 2.9 | 9.88 | | 37.0 | |
| 7-day | 0.81 | 8.84 | −1.04 | 37.6 | 0.61 |
| 14-day | 0.83 | 8.49 | −1.39 | 38.6 | 1.61 |
| 21-day | 0.68 | 8.13 | −1.75 | 38.3 | 1.32 |
| 28-day | 0.96 | 7.24 | −2.64 | 39.9 | 2.91 |
| LH-52 | | | LH52 | | |
| Initial | 3.9 | 11.86 | | 37.0 | |
| 7-day | 0.82 | 11.75 | −0.11 | 36.8 | −0.19 |
| 14-day | 1.31 | 11.80 | −0.06 | 38.2 | 1.25 |
| 21-day | 1.25 | 11.71 | −0.15 | 36.1 | −0.90 |
| 28-day | 1.52 | 11.74 | −0.12 | 38.0 | 1.01 |

LH47 was the control sample in this study.

### Data on Formulation with a Magnesium Based Layered Silicate and Improvement on its Chemical Stability

LH39 was prepared as LH47 except a hectorite clay was used instead of a sodium bentonite.

TABLE 3
Data on pH and color changes under lab
storage conditions @ ambient temperature

| | Aging | | | | | | |
|---|---|---|---|---|---|---|---|
| | Period | % | | 5% | | Hunter | |
| Sample | of Time | Moisture | Change | pH | Change | L | Change |
| LH47 | Initial | 1.9 | | 8.9 | | 39.6 | |
| | 3-month | 2.4 | 0.5 | 8.0 | −0.9 | 40.3 | 0.7 |
| | 6-month | 2.4 | 0.5 | 8.2 | −0.7 | 41.6 | 2.0 |
| | 12-month | 3.2 | 1.3 | 7.5 | −1.4 | 43.9 | 4.4 |
| | 24-month | 3.6 | 1.7 | 6.0 | −2.9 | 51.4 | 11.8 |
| LH39 | Initial | 2.5 | | 8.9 | | 35.2 | |
| | 3-month | 4.2 | 1.7 | 8.7 | −0.2 | 33.6 | −1.6 |
| | 6-month | 3.9 | 1.4 | 7.4 | −1.5 | 34.6 | −0.6 |
| | 12-month | 3.9 | 1.4 | 7.8 | −0.9 | 36.0 | 0.9 |
| | 24-month | 2.0 | −0.5 | 6.3 | −2.5 | 35.8 | 0.6 |

LH47 was the control (Example 7) in this study.

### Data on Formulations with Elemental Sulfur and Sodium Silicate

15NVEX3 was prepared as described in Example 10, and 15NVEX4 was prepared as described in Example 8 except the trona was replaced by sodium silicate (PQ Corporation, SS 20 grade).

TABLE 4
Formulations with Elemental Sulfur and Sodium Silicate
as Chemical Additives

| Product Code | 15NVEX3 | 15NVEX4 |
|---|---|---|
| Lab ID | LH72 | LH73 |
| Sodium Bentonite | 55.0 | 60.0 |
| Copper Sulfate hydrated | 16.0 | 16.0 |
| Sodium Sulfide hydrated | 12.6 | 12.6 |
| Trona hydrated | 11.4 | |
| Sodium Silicate | | 11.4 |
| Elemental Sulfur | 5.0 | |
| Total Dry Weight | 100.0 | 100.0 |
| Estimated water to inject | 9.9 | 9.9 |
| Unit: parts by weight | | |

TABLE 5
Data on Color Changes @ Elevated Oven Temperatures

| | | | |
|---|---|---|---|
| Product Name | 15NVEX3 | 15NVEX4 | LH47 |

100° C. 4-Day Oven Heat Aging Test

| | | | |
|---|---|---|---|
| L Initial | 40.1 | 44.9 | 44.8 |
| L After 4-day | 40.6 | 45.9 | 48.1 |
| ΔL* | 0.5 | 1.0 | 3.2 |

160° C. 24 Hr Oven Heat Aging Test

| | | | |
|---|---|---|---|
| L Initial | 40.1 | 44.9 | 44.8 |
| L After 24-hr | 41.8 | 46.2 | 48.9 |
| ΔL* | 1.7 | 1.3 | 4.1 |

LH47 was the control in this study.

### Data on Elemental Sulfur and Sodium Silicate Combination and its Stability Data

15NVEX8 was prepared as Example 10 except the bentonite/sulfur pre-blend was in a different ratio, and trona was replaced by sodium silicate in a different ratio, the detailed formulation was disclosed in Table 6. LH47 was the control in this study.

TABLE 6
Formulation with both elemental sulfur and sodium silicate

| Product Code | 15NVEX8 |
|---|---|
| Clay Substrate | 60.0 |
| Copper Sulfate | 16.0 |
| hydrated | |
| Sodium Sulfide | 12.6 |
| hydrated | |
| Sodium Silicate | 7.4 |
| Elemental Sulfur | 4.0 |
| Total Dry Weight | 100.0 |
| Unit: parts by weight | |

TABLE 7
Data on color change @ 160° C.

| Product Name | 15NVEX8 | LH47 |
|---|---|---|
| 160° C. 24-Hr Oven Heat Aging Test | | |
| L Initial | 42.1 | 44.8 |
| L After 24-hr | 44.7 | 48.9 |
| ΔL* | 2.6 | 4.1 |

### Data on the Formulation with Hither Copper Sulfide Concentration and Its Impact on Stability

Mercury sorbent with a higher copper sulfide concentration using the formation described in Table 8 with a similar process as described in Example 7.

TABLE 8
Formulation with higher copper sulfide content

| parts by weight | 13NVEX2 | LH47 |
|---|---|---|
| bentonite substrate | 65.3 | 74.9 |
| copper sulfate | | |
| hydrated | 17.7 | 11.9 |
| sodium sulfide | | |
| hydrated | 14.0 | 9.7 |
| sodium chloride | 3.0 | 3.5 |
| Raw Materials Total | 100.0 | 100.0 |

TABLE 9
Data on color change @ 160° C.

| | |
|---|---|
| 13NVEX2 | LH47 |

160° C. 24-Hr Oven Heat Aging Test

| | | |
|---|---|---|
| L Initial | 45.6 | 44.8 |
| L After 24-hr | 50.3 | 48.9 |
| ΔL* | 4.7 | 4.1 |

The LH47 was the control in this study.

### Data on the Formulation without Coroner Sulfide

No stability issues are expected with this type of formulation.

### Example 11

Bentonite powder and sulfur powder (from Harwick Standard Distribution Corporation, grade 104) were blended in a ratio of 93.3: 6.7 by weight, and then this mixture was fed into a 5″ Readco continuous processor at a feed rate of 900 lb/hr. About 0.25 gallon/minute of water and 1.04 gallon/minute of quaternary ammonium chloride (a.k.a. “quat”)(ARQUAD® 2HT from Akzo Nobel, bis(hydrogenated tallow alkyl)dimethyl ammonium chloride, ˜83% active) were also fed in the Readco processor through two independent ports in sequence. The discharged extrudates from the processor were sent to a dryer, the dried extrudates were further milled and the granular particles between 18 and 40 mesh (U.S. Standard mesh) with moisture content less than 5% by weight were collected as the finished product.

The foregoing description is given for clearness of understanding only, and no unnecessary limitations should be understood therefrom, as modifications within the scope of the invention may be apparent to those having ordinary skill in the art.

What is claimed is:

1. A method of manufacturing a mercury sorbent material comprising:
adding mercury sorbent components, optionally made into a pre-mixture, to a shearing apparatus, the mercury sorbent components comprising:
a first dry clay, a second dry clay, or a combination of a first dry clay and a second dry clay;
a dry copper source; and
a first dry sulfur source, a second dry sulfur source, or a combination of a first and a second dry sulfur source;
wherein at least one member of the group of conditions (a), (b), and (c) applies;
condition (a) the mercury sorbent also comprises an additive and the additive is a dispersant, an oxygen scavenger, a moisture scavenger, an intercalation reagent, or any combination thereof;
condition (b) the second dry clay is present and is selected from the group consisting of talc, chloritic talc, chlorite clay, atapulgite, sepiolite clay, imogolite clay, halloysite clay, perlite, lignite, bleaching earth clay, and combinations thereof;
condition (c) the second dry sulfur source is present and is selected from the group consisting of elemental sulfur, sodium trithiocarbonate, silane with thiol functionality, sodium dimethyl-dithiocarbamate, sodium salt of trimecapto-s-triazine, and combinations thereof;
and forming the mercury sorbent material by shearing the mercury sorbent components using the shearing apparatus;
wherein a powder X-ray diffraction pattern of the mercury sorbent material is substantially free of a diffraction peak at 2.73±0.01 Å.

2. The method of claim 1, wherein the mercury sorbent components are made into the mercury sorbent pre-mixture, and making the mercury sorbent pre-mixture comprises:
either
making a copper/clay mixture by admixing a dry clay and a dry copper source;
making a sulfur/clay mixture by admixing a dry clay and a dry sulfur source;
and
admixing the copper/clay mixture and the sulfur/clay mixture to form the mercury sorbent pre-mixture;
or
admixing a dry clay, a dry copper source, and a dry sulfur source to form the mercury sorbent pre-mixture.

3. The method of claim 2, wherein the dry clay has less than about 15% by weight water.

4. The method of claim 1, wherein shearing comprises passing the mercury sorbent components or pre-mixture through an extruder and wherein the method further comprises adding water to the mercury sorbent components or pre-mixture such that the extruded components or pre-mixture has about 15% to about 40% by weight water;
or
shearing comprises passing the components or pre-mixture through a pin mixer and wherein the method further comprises adding water to the components or pre-mixture such that when mixed in the pin mixer, the components or pre-mixture contains about 15% to about 40% weight water.

5. The method of claim 1, wherein the mercury sorbent material comprises a pH stabilizing agent and the pH stabilizing agent is sodium carbonate, sodium bicarbonate, lime (CaO), hydrated lime, trona (trisodium hydrogen-dicarbonate dihydrate), calcium carbonate (calcite), calcium magnesium carbonate (dolomite), or a combination thereof.

6. The method of claim 5, wherein the pH stabilizing agent is added to one or more mercury sorbent components, to the shearing apparatus, to the mercury sorbent material after shearing, to the mercury sorbent material after optionally being dried after shearing, or any combination thereof.

7. The method of claim 5, wherein the mercury sorbent material produced comprises 0.1 wt. % to 50 wt. % of the pH stabilizing agent when the water or solvent content of the material is not more than 5 wt. %.

8. The method of claim 1, wherein the first dry clay is present and the first dry clay comprises a phyllosilicate selected from the group consisting of bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and mixtures thereof.

9. The method of claim 1, wherein the dry copper source comprises a copper salt selected from the group consisting of anhydrous copper compounds selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof; and/or a copper compound hydrate with the copper compound of the copper compound hydrate being selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof.

10. The method of claim 1, wherein the first dry sulfur source is present, and the first dry sulfur is selected from the group consisting of sodium sulfide, sodium sulfide trihydrate, sodium sulfide nonahydrate, sodium disulfide, sodium polysulfide, ammonium sulfide, ammonium disulfide, ammodium polysulfide, potassium sulfide, potassium disulfide, potassium polysulfide, calcium polysulfide, hydrogen sulfide, hydrogen disulfide, aluminum sulfide, magnesium sulfide, thiolacetic acid, thiobenzoic acid, and mixtures thereof.

11. The method of claim 1, wherein the first clay is present and the first clay is sodium bentonite, the copper source is copper sulfate pentahydrate, and the first dry sulfur source is present and is sodium sulfide trihydrate.

12. The method of claim 1, wherein the second clay is present; or the first dry clay source and the second dry clay are present at a ratio of the weight the second dry clay to the weight of the first dry clay is in the range of 1:99 to 99:1.

13. The method of claim 1, wherein the second dry sulfur source is present; or the first dry sulfur source and the second dry sulfur source are present at a weight ratio of the second dry sulfur source to the first dry sulfur source iii the range of 0.01:1 to 1:1.

14. The method of claim 1, wherein an additive is present and the additive is added to the mercury sorbent pre-mixture, is added to one or more mercury sorbent components, to the shearing apparatus, to the mercury sorbent material after shearing, to the mercury sorbent material after optionally being dried after shearing, or any combination thereof.

15. The method of claim 14, wherein the additive is a dispersant selected from the group consisting of tetrasodium pyrophosphate, sodium silicate, sodium polyacrylates, low molecular weight sodium polyaspartates, medium molecular weight (MO polyaspartates, high medium molecular weight polyaspartates, and combinations thereof;
wherein the mercury sorbent material produced comprises 0.1 wt. % to 10 wt. % of the additive when the water or solvent content of the material is not more than 5 wt. %.

16. The method of claim 14, wherein the additive is additive is present and the additive is an oxygen scavenger, and the additive is sodium bisulfate, butylated hydroxytoluene, or a combination thereof; and
wherein the mercury sorbent material produced comprises 0.001 wt. % to 10 wt. % of the additive when the water or solvent content of the material is not more than 5 wt. %.

17. The method of claims 14, wherein the additive is a moisture scavenger, and the additive is calcium sulfate, calcium oxide, calcium hydroxide, or a combination thereof; and
wherein the mercury the mercury sorbent material produced comprises 0.001 wt. % to 15 wt. % of the additive when the water or solvent content of the material is not more than 5 wt. %.

18. The method of claim 1, wherein the additive is present and the additive is an intercalation reagent, and the additive is tetramethylammonium chloride, tetrabutylammonium chloride, trimethylcetylammonium chloride, tetraethoxysilane, or a combination thereof; and
wherein the mercury sorbent material produced comprises 0.001 wt. % to 15 wt. % of the additive when the water or solvent content of the material is not more than 5 wt. %.

19. A mercury sorbent material comprising a material that comprises
a first clay, a second clay, or a combination of a first clay and a second clay;
a dry copper source; and
a first sulfur source, a second sulfur source, or a combination of a first and a second sulfur source;
wherein at least one member of the group of conditions (a), (b), and (c) applies;
condition (a) the mercury sorbent also comprises an additive and the additive is a dispersant, an oxygen scavenger, a moisture scavenger, an intercalation reagent, or any combination thereof;
condition (b) the second clay is present and is selected from the group consisting of talc, chloritic talc, chlorite clay, atapulgite, sepiolite clay, imogolite clay, halloysite clay, perlite, lignite, bleaching earth clay, and combinations thereof;
condition (c) the second sulfur source is present and is selected from the group consisting of elemental sulfur, sodium trithiocarbonate, silane with thiol functionality, sodium dimethyl-dithiocarbamate, sodium salt of trimecapto-s-triazine, and combinations thereof;
and
wherein mercury sorbent material is substantially free of a clay/covellite composite as determined by powder X-ray diffraction, the powder X-ray diffraction pattern being substantially free of a peak at 2.73±0.1 Å.

20. The mercury sorbent material of claim 19, wherein if the first clay is present, the first clay comprises a phyllo silicate selected from the group consisting of bentonite, montmorillonite, hectorite, beidellite, saponite, nontronite, volkonskoite, sauconite, stevensite, fluorohectorite, laponite, rectonite, vermiculite, illite, a micaceous mineral, makatite, kanemite, octasilicate (illierite), magadiite, kenyaite, attapulgite, palygorskite, sepoilite, and mixtures thereof;
wherein the dry copper source comprises a copper salt selected from the group consisting of anhydrous copper compounds selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof; and/or a copper compound hydrates with the copper compound of the copper compound hydrate being selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, copper alloy, and mixtures thereof;
and
wherein if the first sulfur source is present, the first sulfur source comprises a member of the group consisting of sodium sulfide, sodium sulfide trihydrate, sodium sulfide nonahydrate, sodium disulfide, sodium polysulfide, ammonium sulfide, ammonium disulfide, ammodium polysulfide, potassium sulfide, potassium disulfide, potassium polysulfide, calcium polysulfide, hydrogen sulfide, hydrogen disulfide, aluminum sulfide, magnesium sulfide, thiolacetic acid, thiobenzoic acid, and mixtures thereof.

21. The mercury sorbent material of claim 20, wherein the mercury sorbent material comprises a pH stabilizing agent and the pH stabilizing agent is sodium carbonate, sodium bicarbonate, lime (CaO), hydrated lime, trona (trisodium hydrogen-dicarbonate dihydrate), calcium carbonate (calcite), calcium magnesium carbonate (dolomite), or a combination thereof.

22. The mercury sorbent material of claim 19, wherein an additive is present; and
wherein the additive is a dispersant selected from the group consisting of tetrasodium pyrophosphate, sodium silicate, sodium polyacrylates, and low molecular weight sodium polyaspartates, medium molecular weight (M_{w}) polyaspartates, high medium molecular weight polyaspartates, and combinations thereof;
the additive is an oxygen scavenger, and the additive is sodium bisulfite, butylated hydroxytoluene, or a combination thereof;
the additive is a moisture scavenger, and the additive is calcium sulfate, calcium oxide, calcium hydroxide, or a combination thereof;
the additive is an intercalation reagent, and the additive is tetramethylammonium chloride, tetrabutylammonium chloride, trimethylcetylammonium chloride, tetraethoxysilane, or a combination thereof;
or any combination thereof.

23. The mercury sorbent material of claim 19, wherein the change in the Hunter L value of the mercury sorbent material after 28 days at 25 ° C. (±3 ° C.) with a relative humidity (rh) in the range of 20% to 50% is not more than 5.

24. The mercury sorbent material of claim 19, wherein the change in the CIE L*value of the mercury sorbent material after 28 days at 25 ° C. (±3 ° C.) with a relative humidity (rh) in the range of 20% to 50% is not more than 5.

25. The mercury sorbent material of claim 19, wherein the change in the Hunter L value of the mercury sorbent material after 96 hours at 100 ° C. (±5 ° C.) with a relative humidity (rh) in the range of 20% to 50% is not more than 3.

26. The mercury sorbent material of claim 19, wherein the change in the Hunter L value of the mercury sorbent material after 24 hours at 160 ° C. (±5 ° C.) with a relative humidity (rh) in the range of 20% to 50% is not more than 3.
